(19) United States
(12) Patent Application Publication
(10) Pub. No.: US 2024/0338579 A1
(43) Pub. Date: Oct. 10, 2024

(54) COSMETIC PRODUCTION ASSISTANCE APPARATUS, COSMETIC PRODUCTION ASSISTANCE METHOD, AND STORAGE MEDIUM

(71) Applicant: NEC Corporation, Minato-ku, Tokyo (JP)

(72) Inventors: Yoji Mori, Tokyo (JP); Ayako Hoshino, Tokyo (JP); Yuya Endo, Tokyo (JP); Yuuki Watanabe, Tokyo (JP); Naruto Yajima, Tokyo (JP)

(73) Assignee: NEC Corporation, Minato-ku, Tokyo (JP)

(21) Appl. No.: 18/293,595

(22) PCT Filed: Sep. 15, 2021
(86) PCT No.: PCT/JP2021/033833

§ 371 Date: Jan. 30, 2024

(51) Int. Cl. G06N 5/04

(52) U.S. Cl. CPC G06N 5/04

(57) ABSTRACT

In order to suitably assist new cosmetic product development, a cosmetic production assistance apparatus (1) includes: a reception section (11) for receiving a request pertaining to new cosmetic product development; an inference section (12) for inferring a production method for producing a new product conforming to the request based on a learned model which has learned a relation between (i) a component and efficacy of an existing product and (ii) a method for producing the existing product; and an output section (13) for outputting information indicating the inferred production method.

### TECHNICAL FIELD

The present invention relates to a cosmetic production assistance apparatus and the like for generating information pertaining to development of a cosmetic.

### BACKGROUND ART

In new cosmetic product development, the following processes are carried out in which: from among huge amounts of combinations of materials and production methods, a combination that seems to be promising for realizing a product concept is selected; a prototype product is produced based on the selected combination; and effects of the prototype product are verified (e.g., see Patent Literature 1 below).

### CITATION LIST

### Patent Literature

### [Patent Literature 1]

Japanese Patent Application Publication Tokukai No. 2017-226612

### SUMMARY OF INVENTION

### Technical Problem

New cosmetic product development needs to repeat the above process until a combination that realizes the product concept is found. Therefore, there is a problem that it takes a lot of labor and a lot of time, and a technique for suitably assisting new cosmetic product development is demanded.

An example aspect of the present invention is accomplished in view of the above problem, and an example object thereof is to provide a technique for suitably assisting new cosmetic product development.

### Solution to Problem

A cosmetic production assistance apparatus in accordance with an example aspect of the present invention includes: a reception means for receiving a request pertaining to new cosmetic product development; an inference means for inferring a production method for producing a new product conforming to the request based on the request and a learned model which has learned a relation between (i) a component and efficacy of an existing product, which is an existing cosmetic product, and (ii) a method for producing the existing product; and an output means for outputting information indicating the production method which has been inferred by the inference means.

In a cosmetic development assistance method in accordance with an example aspect of the present invention: a computer receives a request pertaining to new cosmetic product development; the computer infers a production method for producing a new product conforming to the request based on the request and a learned model which has learned a relation between (i) a component and efficacy of an existing product, which is an existing cosmetic product, and (ii) a method for producing the existing product; and the computer outputs information indicating the production method which has been inferred.

A cosmetic development assistance program in accordance with an example aspect of the present invention causes a computer to carry out: a process of receiving a request pertaining to new cosmetic product development; a process of inferring a production method for producing a new product conforming to the request based on the request and a learned model which has learned a relation between (i) a component and efficacy of an existing product, which is an existing cosmetic product, and (ii) a method for producing the existing product; and a process of outputting information indicating the production method which has been inferred.

### Advantageous Effects of Invention

According to an example aspect of the present invention, it is possible to suitably assist new cosmetic product development.

### BRIEF DESCRIPTION OF DRAWINGS

FIG. 1 is a block diagram illustrating a configuration of a cosmetic production assistance apparatus in accordance with a first example embodiment of the present invention.

FIG. 2 is a flowchart illustrating a flow of a cosmetic production assistance method in accordance with the first example embodiment of the present invention.

FIG. 3 is a diagram illustrating learning of feature quantities in graph-based relationship learning.

FIG. 4 is a block diagram illustrating a configuration of a cosmetic production assistance apparatus in accordance with a second example embodiment of the present invention.

FIG. 5 is a diagram illustrating an example of calculating a recommendation level by an evaluation section.

FIG. 6 is a diagram illustrating an example of presenting an existing product corresponding to a request.

FIG. 7 is a diagram for illustrating a method for identifying a similar product by a link prediction section.

FIG. 8 is a diagram illustrating an example of presenting basis information based on a prediction result of a probability that a predetermined property appears in a new product.

FIG. 9 is a flowchart illustrating a flow of a process carried out by the cosmetic production assistance apparatus in accordance with the second example embodiment of the present invention.

FIG. 10 is a diagram illustrating an overview of a cosmetic production assistance method in accordance with a third example embodiment of the present invention.

FIG. 11 is a block diagram illustrating a configuration of a cosmetic production assistance apparatus in accordance with the third example embodiment of the present invention.

FIG. 12 is a flowchart illustrating a flow of a process carried out by the cosmetic production assistance apparatus in accordance with the third example embodiment of the present invention.

FIG. 13 is a diagram illustrating an overview of a cosmetic production assistance method in accordance with a fourth example embodiment of the present invention.

FIG. 14 is a block diagram illustrating a configuration of a cosmetic production assistance apparatus in accordance with the fourth example embodiment of the present invention.

FIG. 15 is a flowchart illustrating a flow of a process carried out by the cosmetic production assistance apparatus in accordance with the fourth example embodiment of the present invention.

FIG. 16 is a diagram illustrating an overview of a cosmetic production assistance method in accordance with a fifth example embodiment of the present invention.

FIG. 17 is a flowchart illustrating a flow of a process carried out by the cosmetic production assistance apparatus in accordance with the fifth example embodiment of the present invention.

FIG. 18 is a diagram illustrating an example of predicting a property of a new product based on a feature quantity calculated from a new product graph and an existing product graph.

FIG. 19 is a configuration diagram for realizing a cosmetic production assistance apparatus by software.

### EXAMPLE EMBODIMENTS

### First Example Embodiment

The following description will discuss a first example embodiment of the present invention in detail, with reference to the drawings. The present example embodiment is a basic form of example embodiments described later.

### (Cosmetic Production Assistance Apparatus)

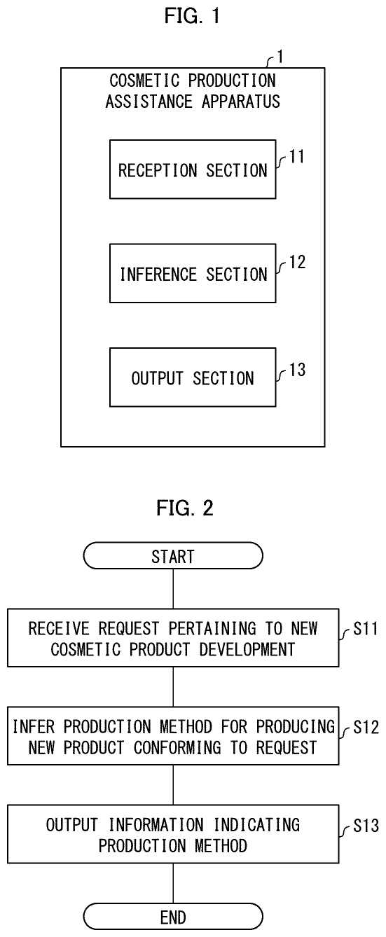

The following description will discuss a configuration of a cosmetic production assistance apparatus 1 in accordance with the present example embodiment, with reference to FIG. 1. FIG. 1 is a block diagram illustrating the configuration of the cosmetic production assistance apparatus 1. As illustrated in FIG. 1, the cosmetic production assistance apparatus 1 includes a reception section (reception means) 11, an inference section (inference means) 12, and an output section (output means) 13.

The reception section 11 receives a request pertaining to new cosmetic product development. The inference section 12 infers a production method for producing a new product conforming to the request based on the request received by the reception section 11 and a learned model which has learned a relation between (i) a component and efficacy of an existing product, which is an existing cosmetic product, and (ii) a method for producing the existing product. The output section 13 outputs information indicating the production method inferred by the inference section 12.

Note that the term “production method” may include, for example, in addition to a blending ratio of components and the like, a method for treating a raw material (a pretreatment method, a mixing time, a mixing rate, a posttreatment method, and the like), and equipment, an apparatus, and the like for use in production. A component or the like of a new product may be inferred as the “production method”.

According to the cosmetic production assistance apparatus 1 having the above configuration, it is possible to present, to a user, a production method for producing a new product that can be said to conform to a request, based on a relation between a component and efficacy of an existing cosmetic and a method for producing the existing product. Therefore, according to the configuration, it is possible to bring about an example advantage of suitably assisting new cosmetic product development.

### (Cosmetic Production Assistance Program)

The functions of the cosmetic production assistance apparatus 1 described above can also be realized by a program. A cosmetic production assistance program in accordance with the present example embodiment causes a computer to carry out: a process of receiving a request pertaining to new cosmetic product development; a process of inferring a production method for producing a new product conforming to the request based on the request and a learned model which has learned a relation between (i) a component and efficacy of an existing product, which is an existing cosmetic product, and (ii) a method for producing the existing product; and a process of outputting information indicating the production method which has been inferred. According to the cosmetic production assistance program, it is possible to bring about an example advantage of suitably assisting new cosmetic product development.

### (Cosmetic Production Assistance Method)

The following description will discuss a cosmetic production assistance method in accordance with the present example embodiment, with reference to FIG. 2. FIG. 2 is a flowchart illustrating a flow of a cosmetic production assistance method in accordance with the first example embodiment of the present invention.

In S11, a computer receives a request pertaining to new cosmetic product development. The request may be received via an arbitrary input apparatus. For example, the request may be received via a mouse, a keyboard, a touch panel, or an audio input apparatus.

In S12, the computer infers a production method for producing a new product conforming to the request based on the request received in S11 and a learned model which has learned a relation between (i) a component and efficacy of an existing product, which is an existing cosmetic product, and (ii) a method for producing the existing product.

In S13, the computer outputs information indicating the production method which has been inferred. The information may be output to an arbitrary apparatus. For example, the information may be output to a display apparatus so that the information is displayed, or the information may be output to an audio output apparatus so that the information is output as audio.

As described above, in the cosmetic production assistance method in accordance with the present example embodiment: a computer receives a request pertaining to new cosmetic product development (S11); the computer infers a production method for producing a new product conforming to the request based on the request received in S11 and a learned model which has learned a relation between (i) a component and efficacy of an existing product, which is an existing cosmetic product, and (ii) a method for producing the existing product (S12); and the computer outputs information indicating the production method which has been inferred in S12 (S13). According to the cosmetic production assistance method, it is possible to bring about an example advantage of suitably assisting new cosmetic product development.

An execution subject of each step in the cosmetic production assistance method described above may be a single computer (e.g., the cosmetic production assistance apparatus 1), or execution subjects of respective steps may be different computers. The same applies to flows described later in the second and subsequent example embodiments.

### (Graph and Learning)

The following description will discuss a graph that is an example of information which can be used to assist cosmetic development in the first example embodiment and in the subsequent example embodiments (hereinafter, referred to as “each example embodiment”). The following description will also discuss learning of the graph and prediction using the graph.

### (Graph)

The graph herein refers to data having a structure composed of a plurality of nodes and links connecting the nodes. A type of link representing a relation between nodes is also called a “relation”. Alternatively, the link may be called an “edge”. The graph roughly includes a directed graph in which each link has directionality, and an undirected graph in which each link has no directionality. It is possible to utilize either a directed graph or an undirected graph. It is also possible to use those graphs in combination.

In a case of using a graph in each example embodiment, a node in the graph only needs to represent a tangible or intangible element pertaining to a cosmetic production method. For example, it is possible to utilize a graph including nodes representing various elements such as:
a component, a component composition, a raw material, and a material;
a product category;
a development concept;
a property (efficacy, fragrance, appearance, side effect, and the like);
product identification information such as a product name and a product ID; and
a production method (production apparatus used, production process, production condition, and the like). Note that the graph may include a plurality of nodes corresponding to a single element. For example, as nodes indicating components of a cosmetic, each of components contained in the cosmetic may be represented by respective individual nodes, such as a node indicating a first component, a node indicating a second component, and a node indicating a third component. The same applies to other elements.

In a case where there are nodes corresponding to elements as described above, a link connecting such nodes represents:
a relation between a certain element and a component;
a relation between a certain element and a product category;
a relation between a certain element and a development concept;
a relation between a certain element and a property;
a relation between a certain element and a product; and the like.
   For example, a link connecting a node indicating a component to a node indicating efficacy may represent a relation in which the component is a factor of the efficacy.

### (Learning and Prediction)

For a graph as described above, a machine learning technique can be applied to carry out graph-based relationship learning. Such learning makes it possible to carry out a classification process or a prediction process using a graph. In each example embodiment, such learning may be carried out as a part of cosmetic production assistance, or a learned graph which has already been subjected to such learning may be used.

In graph-based relationship learning, first, a feature quantity of each node is calculated. The feature quantity may be in, for example, a vector form. By representing a feature quantity of each node by a feature quantity vector, it is possible to carry out learning also for a graph in which nodes of various forms mixedly exist. For example, graph-based relationship learning can also be carried out for a graph including an image, a numerical value, and the like indicating various elements as described above.

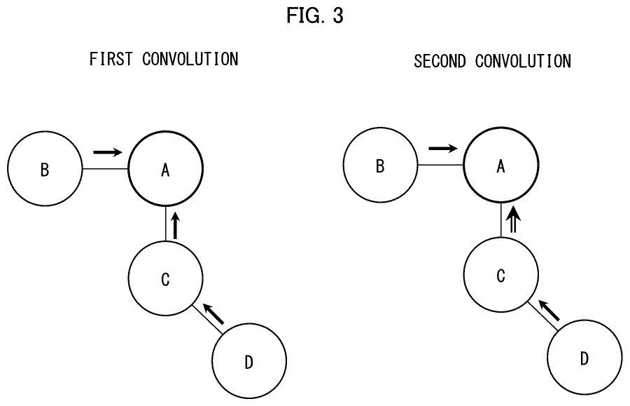

Next, the feature quantity of each node is updated based on a link connected to that node and a node which is a connection destination of the link. This process is similar to a convolution process in a convolutional neural network. This will be described with reference to FIG. 3. FIG. 3 is a diagram illustrating learning of feature quantities in graph-based relationship learning.

In a graph illustrated in FIG. 3, four nodes A through D are included. The nodes B and C are connected to the node A, and the node D is connected to the node C. After calculating initial feature quantities of these four nodes, a plurality of times of convolution are carried out as described below to update the feature quantities of the respective nodes.

In the first convolution, feature quantities of the nodes B and C connected to the node A are each multiplied by a predetermined weight and are then added to an initial feature quantity of the node A. For the node C, a feature quantity of the node D is multiplied by a predetermined weight and is then added to an initial feature quantity of the node C. Note that, in a case of an effective graph, the weight is adjusted according to a direction of the link.

In the second convolution, similarly to the first convolution, a feature quantity of a node linked to each node is multiplied by a predetermined weight, and is then added to a feature quantity of the each node. Here, the feature quantity of the node C reflects the feature quantity of the node D by the first convolution. Therefore, by the second convolution, not only the feature quantity of the node C but also the feature quantity of the node D are reflected in the node A.

By repeating the above-described process by a number of times corresponding to the hierarchy of nodes, feature quantities of nodes which are directly or indirectly connected to each other by links are mutually reflected. In graph-based relationship learning, a weight value used for the above-described weighting is optimized based on a known relationship between nodes. By using such a learned graph (which can also be called a learned model), it is possible to predict an inter-node relation and predict a link destination node, as described below.

### (Inter-Node Relation Prediction)

By carrying out the learning described above, it is possible to predict an inter-node relation which is not explicitly indicated in the original graph. In a case of carrying out inter-node relation prediction, a user may specify two nodes and make a request for returning a relation between those nodes. For example, in a case where a request of inquiring about a relation between a node of “product A” and a node of “moisture retaining property” is input from a user, it is possible to predict, by inter-node relation prediction, that a relation (i.e., a link) that connects these nodes is “efficacy”. In the inter-node relation prediction, it is possible to calculate a probability (likelihood) of a prediction result. The same applies to node prediction described below.

### (Node Prediction)

By carrying out the above-described learning, it is also possible to predict a node that is connected to a certain node by a predetermined link. In a case of carrying out node prediction, a user may specify a single node and a link starting from that single node, and make a request for returning a link destination node. For example, it is assumed that a request for inquiring about a node connected to a node of “product A” by a link of “efficacy” is input from a user. In this case, for example, it is possible to predict, by node prediction, whether a node connected to the node of “product A” by the link of “efficacy” is “moisture retaining property” or “prevention of drying”.

### Second Example Embodiment

### (Apparatus Configuration)

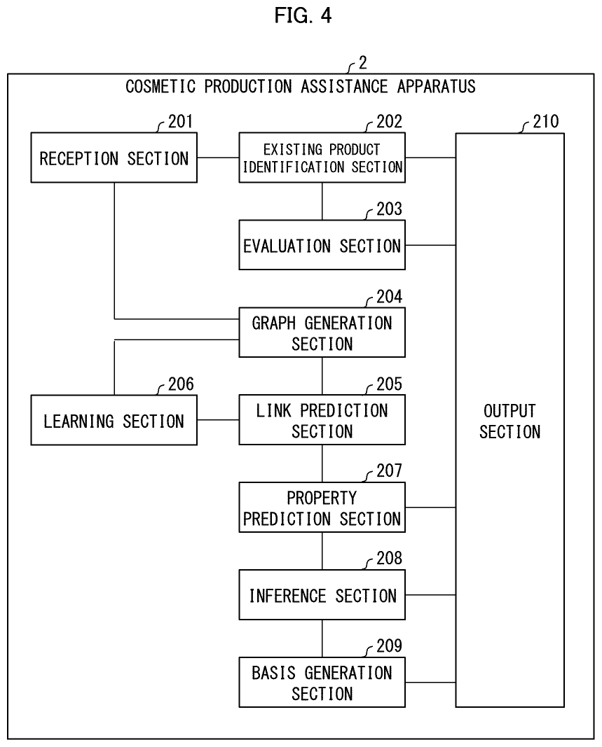

The following description will discuss a configuration of a cosmetic production assistance apparatus 2 in accordance with a second example embodiment of the present invention, with reference to FIG. 4. FIG. 4 is a block diagram illustrating the configuration of the cosmetic production assistance apparatus 2 in accordance with the present example embodiment.

As illustrated in FIG. 4, the cosmetic production assistance apparatus 2 includes a reception section 201, an existing product identification section 202, an evaluation section 203, a graph generation section 204, a link prediction section 205, a learning section 206, a property prediction section 207, an inference section 208, a basis generation section 209, and an output section 210.

In addition to these constituent elements, the cosmetic production assistance apparatus 2 may include an input apparatus for receiving an input operation by a user, an output apparatus for outputting data output by the cosmetic production assistance apparatus 2, a communication apparatus for enabling the cosmetic production assistance apparatus 2 to communicate with another apparatus, and the like. An output mode of the output apparatus may be arbitrarily set, and may be, for example, display output or audio output.

The reception section 201 receives a request pertaining to new cosmetic product development. This request may include, for example, efficacy demanded of a new product, a raw material or a component to be used in a new product, a production method to be applied in production of a new product, and the like.

The existing product identification section 202 identifies, based on nodes and links included in an existing product graph, an existing product that has a property conforming to the request which has been received by the reception section 201. Note that the term “property” indicates a character or a state. For example, efficacy, presence or absence of a side effect, contents of the side effect, texture, being a liquid or a solid, and the like are also included in the scope of the property.

The existing product graph is a graph in which one or more existing products are represented by nodes each indicating a component, efficacy, or a production method of each of the one or more existing products and edges indicating relationships between the nodes. The existing product graph is a learned model and is a learned graph which has learned nodes and relationships between the nodes. The existing product graph can also be called a knowledge graph. A graph corresponding to a single existing product may be referred to as an existing product graph, or a graph corresponding to a plurality of existing products may be referred to as an existing product graph.

The evaluation section 203 evaluates the existing product identified by the existing product identification section 202 and calculates a recommendation level thereof. Various criteria for evaluation can be applied. For example, evaluation can be carried out on the basis of a degree of conformity to a request. For example, the following description assumes that a request includes efficacy demanded of a new product. In this case, the evaluation section 203 may calculate the recommendation level so that a recommendation level of an existing product corresponding to an existing product graph including a node indicating that efficacy is higher than a recommendation level of an existing product corresponding to an existing product graph which does not include a node indicating that efficacy.

The graph generation section 204 generates, based on information pertaining to a new product which a user wants to produce, a new product graph representing that new product in the form of graph. Specifically, the graph generation section 204 generates a new product graph representing a new product, which a user wants to produce, by nodes each indicating a component, efficacy, or a production method of the new product and edges each representing a relationship between nodes. Note that information pertaining to a new product which the user wants to produce is included in the request received by the reception section 201.

The link prediction section 205 identifies an existing product similar to the new product by link prediction using the new product graph and the existing product graph, the link prediction being carried out for predicting a relationship between nodes which are not connected to each other by a link in the new product graph and the existing product graph. Hereinafter an existing product similar to the new product is referred to as a similar product.

The learning section 206 learns, based on various kinds of information pertaining to an existing product, a relationship between nodes included in an existing product graph, and generates a learned existing product graph. Unless otherwise specified, the existing product graph refers to a graph which has been subjected to learning by the learning section 206. The learned existing product graph may be read into the cosmetic production assistance apparatus 2. In such a case, the learning section 206 may be omitted.

The property prediction section 207 predicts a property of a new product. Specifically, the property prediction section 207 identifies, with reference to an existing product graph of the similar product identified by the link prediction section 205, a property that is indicated in that existing product graph. The property prediction section 207 sets the property thus identified as a result of predicting a property of the new product.

The inference section 208 infers a production method for producing a new product conforming to the request based on the request received by the reception section 201 and a learned model which has learned a relation between (i) a component and efficacy of an existing product, which is an existing cosmetic product, and (ii) a method for producing the existing product.

As described above, the learned model may be an existing product graph in which one or more existing products are represented by nodes each indicating a component, efficacy, or a production method of each of the one or more existing products and edges indicating relationships between the nodes. According to the configuration, it is possible to infer a proper production method while taking into consideration a mutual relationship between a component, efficacy, and a production method of an existing product.

The basis generation section 209 generates basis information indicating a basis of inference carried out by the inference section 208. Various techniques can be applied as a method of generating basis information. The method for generating basis information will be described later.

As described above, the output section 210 outputs various kinds of information generated by the cosmetic production assistance apparatus 2, such as information indicating a production method inferred by the inference section 208. An output destination of the information may be arbitrarily set. For example, in a case where the cosmetic production assistance apparatus 2 includes an output apparatus as described above, the information may be output to the output apparatus. Alternatively, for example, the information may be output to an output apparatus provided outside the cosmetic production assistance apparatus 2.

As described above, the request received by the reception section 201 may include information indicating efficacy that is demanded of a new product. In this case, the inference section 208 may infer, as a production method for producing a new product having the efficacy, a production method that includes at least one of elements of a production method for producing an existing product that correspond to a node and a link which are included in the existing product graph and which indicate the efficacy.

An element included in a production method for producing an existing product corresponding to a node and a link indicating efficacy that is demanded of a new product may be a factor for expressing the efficacy. Therefore, according to the configuration, it is possible to infer a production method for producing a new cosmetic product having intended efficacy.

As described above, the cosmetic production assistance apparatus 2 includes the link prediction section 205 for identifying, by link prediction using a new product graph and the existing product graph, an existing product having a predetermined relationship with a new product, the new product graph including a plurality of nodes pertaining to production of the new product to be developed, and the link prediction being carried out for predicting a relationship between nodes which are not connected to each other by a link in the new product graph and the existing product graph, and the inference section 208 infers a production method for producing a new product conforming to the request on the basis of a method for producing the existing product which has been identified by the link prediction section 205.

A production method for producing an existing product having a predetermined relationship with a new product to be developed is information useful for inferring a production method for producing a new product that conforms to a request. According to the configuration, it is possible to infer a production method for producing a new product conforming to a request, while taking into consideration the useful information.

As described above, the cosmetic production assistance apparatus 2 includes the existing product identification section 202 that identifies, based on nodes and links included in an existing product graph, an existing product that has a property conforming to the request which has been received by the reception section 201.

An existing product having a property conforming to a request is information useful for inferring a production method for producing a new product conforming to the request. Therefore, by providing the existing product identification section 202, it is possible to infer a production method for producing a new product conforming to a request, while taking into consideration the useful information. For example, the information indicating an existing product identified by the existing product identification section 202 may be output by the output section 210. Thus, it is possible to allow a user to recognize what kind of existing product has a property conforming to the request.

### (Method of Calculating Recommendation Level)

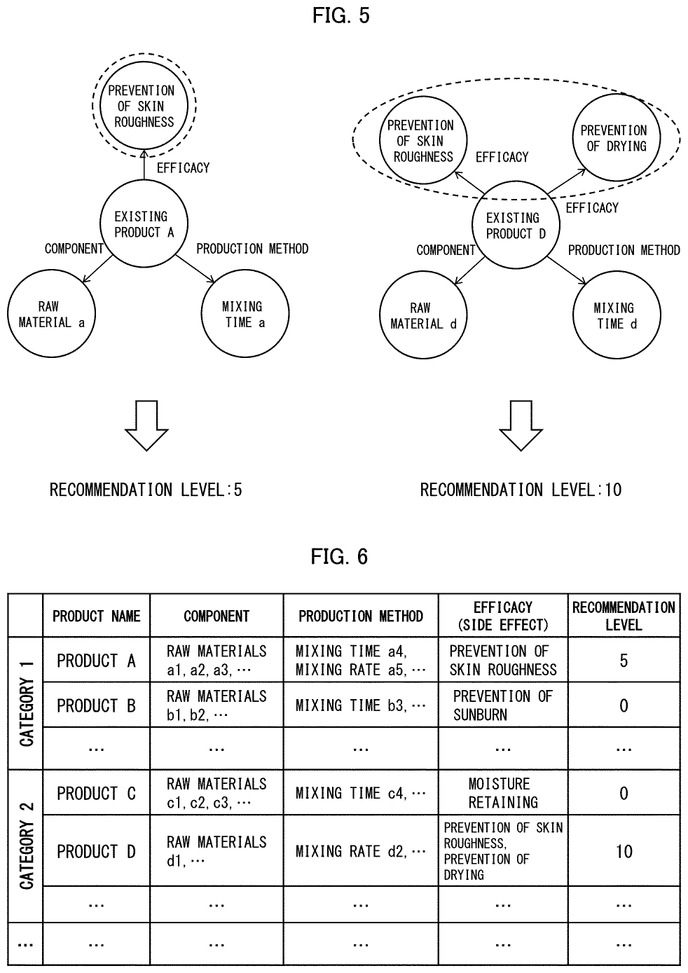

FIG. 5 is a diagram illustrating an example of calculating a recommendation level by the evaluation section 203. In the example of FIG. 5, a recommendation level is calculated for each of existing products A and D. In this example, it is assumed that a request received by the reception section 201 indicates, as efficacy demanded of a new product, two types of efficacy which are “prevention of skin roughness” and “prevention of drying”. In this example, it is assumed that a recommendation level at the time when one type of efficacy conforms to a request is set to “5”.

An existing product graph of the existing product A includes a node indicating that the existing product A has efficacy of “prevention of skin roughness”. Therefore, the evaluation section 203 calculates a recommendation level of the existing product A to be “5”. Meanwhile, an existing product graph of the existing product D includes a node indicating that the existing product D has efficacy of “prevention of skin roughness” and a node indicating that the existing product D has efficacy of “prevention of drying”. Therefore, the evaluation section 203 calculates a recommendation level of the existing product D to be “10”. As such, by setting a degree of conformity to a request and a recommendation level corresponding to the degree in advance, the evaluation 3 can calculate a recommendation level of each existing product.

The evaluation section 203 may set a recommendation level of an existing product to be higher as a degree of similarity of that existing product to a new product increases. For example, the following description assumes a case in which a new product graph includes nodes and links indicating a plurality of raw materials of a new product and blending ratios of those raw materials. In this case, a recommendation level of an existing product of which raw materials are common to a new product may be higher than that of an existing product of which raw materials are not common to the new product. In addition, a recommendation level of an existing product having a blending ratio closer to that of the new product may be higher.

Besides the above examples, the evaluation section 203 may, for example, set a recommendation level of an existing product that can be produced with production equipment which can be used by a user to be higher than an existing product that cannot be produced with production equipment which can be used by a user. Note that production equipment which can be used by a user may be input as a request. The evaluation section 203 may calculate a recommendation level by combining the above-described various evaluation criteria.

(Presentation Example of Existing Product in Accordance with Request)

The output section 210 may output, in the form illustrated in FIG. 6 for example, an existing product identified by the existing product identification section 202 in accordance with a request received by the reception section 201 and a recommendation level calculated by the evaluation section 203. FIG. 6 is a diagram illustrating an example of presenting an existing product in accordance with a request.

In the example of FIG. 6, a product name, components, a production method, efficacy (or side effect), and a recommendation level of an existing product identified by the existing product identification section 202 are presented. Moreover, existing products are presented separately for each category. Such various kinds of information can be extracted from an existing product graph. By presenting information as illustrated in FIG. 6 to a user, the user can infer components and a production method for imparting intended efficacy to a new product.

### (Identification of Similar Product)

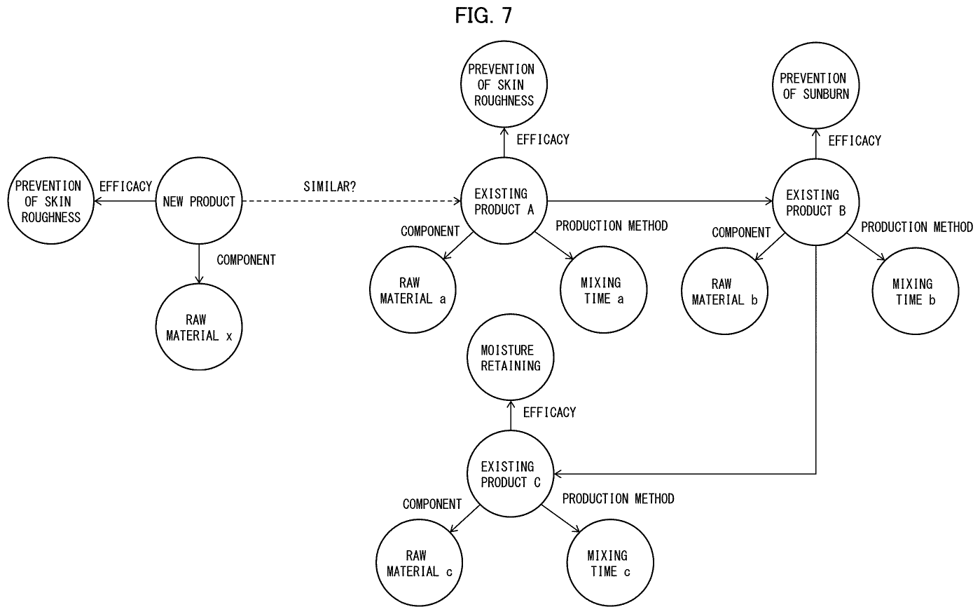

FIG. 7 is a diagram for illustrating a method for identifying a similar product by the link prediction section 205. FIG. 7 shows an existing product graph in which existing products A through C are represented by nodes each indicating a component, efficacy, or a production method of the existing product, and edges each representing a relationship between nodes. For example, a node of “existing product A” and a node of “prevention of skin roughness” are connected to each other by an edge indicating “efficacy”. Thus, it is expressed that the existing product A has efficacy of prevention of skin roughness.

The existing product graph illustrated in FIG. 7 includes nodes of a plurality of existing products, i.e., the existing products A through C. Note, however, that a graph composed only of nodes pertaining to a single existing product may be referred to as an existing product graph. In this case, a similar product is identified using a plurality of existing product graphs corresponding to the respective plurality of existing products.

Such an existing product graph can be generated based on a component, efficacy, and a production method of each existing product. Further, by learning a relation between a component and efficacy indicated in an existing product graph and a production method for producing an existing product, it is possible to infer a relation between a component and efficacy in a new product and a production method for producing an existing product.

FIG. 7 also illustrates a new product graph in which a new product is represented by nodes each indicating a component, efficacy, or a production method of the new product, and edges each representing a relationship between nodes. More specifically, the new product graph illustrated in FIG. 7 includes nodes and links indicating that the new product has efficacy of “prevention of skin roughness” and nodes and links indicating that the new product contains a component “raw material x”.

The graph generation section 204 generates a new product graph as described above based on a request pertaining to a new product received by the reception section 201. That is, a new product graph as illustrated in FIG. 7 is generated in a case where a request has been received which indicates that efficacy demanded of a new product is efficacy of prevention of skin roughness, and that a raw material x is used in the new product.

The link prediction section 205 can identify an existing product that has a predetermined relationship with a new product by using the new product graph generated in this manner and an existing product graph. For example, it is possible to identify an existing product similar to a new product, i.e., a similar product described above. In addition, it is also possible to identify an existing product that is not similar to the new product, an existing product that belongs to the same classification as the new product, an existing product that has efficacy common to the new product, and the like. In the present example embodiment, an example will be described in which a similar product is identified. However, an existing product having another relationship with the new product may be identified. Such an identification result can also be used to infer a production method for producing a new product, as with an identification result of a similar product.

The identification can be realized by link prediction for predicting a relationship between nodes which are not connected to each other by a link in the new product graph and the existing product graph. For example, as indicated by the broken line in FIG. 7, a node of “new product” in the new product graph is not connected by a link to a node of “existing product A” in the existing product graph.

The link prediction section 205 can predict, by carrying out link prediction, a probability that a relationship between these nodes is “similar”. The link prediction section 205 can predict, in a similar manner, a probability that a relationship between the node of “new product” and a node of the existing product B or C included in the existing product graph is “similar”. Then, the link prediction section 205 can identify a similar product based on the predicted probability. For example, the link prediction section 205 may identify, as a similar product, an existing product for which a predicted probability value is equal to or more than a threshold.

The link prediction section 205 can identify, as an existing product having a predetermined relationship with the new product, an existing product that conforms to a condition set in advance or a condition set by a user. For example, it is also possible to identify, as a similar product, an existing product whose components are at least partially common to the new product, and to identify, as a similar product, an existing product whose production method is at least partially common to the new product.

### (Method of Generating Basis Information)

The following description will discuss a method for generating basis information by the basis generation section 209. As described above, various techniques can be applied as a method of generating basis information. For example, in a case where information indicating efficacy that is demanded of a new product is included in a request received by the reception section 201, the basis generation section 209 may generate, as a basis of inference, basis information which includes information pertaining to an existing product which has efficacy identical with the efficacy indicated in the request (i.e., efficacy demanded of the new product). The output section 210 may output the generated basis information.

An existing product graph of an existing product having efficacy identical with that demanded of the new product includes a node indicating that efficacy. Therefore, in a case of generating basis information as described above, the basis generation section 209 may first identify an existing product graph including a node indicating that efficacy. Then, the basis generation section 209 may generate basis information based on the identified existing product graph. For example, the basis generation section 209 may generate basis information indicating a name and efficacy of an existing product indicated in the identified existing product graph.

Information pertaining to an existing product which has efficacy identical with efficacy that is demanded of a new product serves as a strong determination basis for determining whether or not a new product produced by the inferred production method has that efficacy. Therefore, according to the configuration, it is possible to give a user a strong determination basis for determining whether or not the inferred production method is effective for imparting intended efficacy to a new product.

Basis information generated by the basis generation section 209 may include information indicating a method for producing an existing product that has efficacy identical with efficacy demanded of a new product. An existing product graph of the existing product having efficacy identical with that demanded of the new product includes a node indicating that efficacy. Therefore, the basis generation section 209 may first identify an existing product graph including a node indicating that efficacy. Then, the basis generation section 209 may generate basis information indicating a production method for producing the existing product, which is indicated in the identified existing product graph. For example, the basis generation section 209 may generate basis information indicating at least one selected from the group consisting of a component and a production method indicated in the identified existing product graph.

A production method for producing an existing product which has efficacy identical with efficacy that is demanded of a new product serves as a strong determination basis for determining whether or not a new product produced by the inferred production method has that efficacy. Therefore, according to the configuration, it is possible to give a user a strong determination basis for determining whether or not the inferred production method is effective for imparting intended efficacy to a new product.

For example, in a case where a production method for producing a new product having efficacy x is requested, the inference section 208 infers components and a production method of a new product having the efficacy x. Here, it is assumed that the inference section 208 has inferred a production method of blending components A and B in a new product. In this case, the basis information generation section 209 may generate basis information indicating that the component A is contained in an existing product X1 which has the efficacy x, and the component B is included in an existing product X2 which has the same efficacy x. Alternatively, in this case, the basis information generation section 209 may generate basis information indicating a production method for producing an existing product X1 (a production method including blending a sentence A) and a production method for producing an existing product X1 (a production method including blending a sentence A).

The basis generation section 209 may generate basis information based on a result of link prediction by the link prediction section 205. In this case, the link prediction section 205 predicts, with use of an existing product graph including a node indicating efficacy demanded of a new product and a new product graph, a probability that a node indicating the efficacy links to a node included in the new product graph. The basis generation section 209 generates basis information corresponding to the predicted probability.

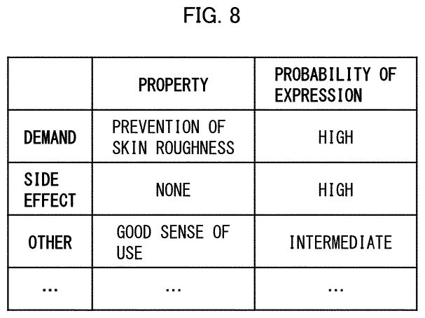

Thus, the basis generation section 209 can generate basis information as illustrated in FIG. 8. FIG. 8 is a diagram illustrating an example of presenting basis information based on a prediction result of a probability that a predetermined property appears in a new product.

The basis information illustrated in FIG. 8 includes properties that are predicted to be possessed by the new product and information indicating a level of a possibility that the new product has each of the properties. Specifically, the basis information illustrated in FIG. 8 includes (i) a requested property, i.e., a property (e.g., efficacy) indicated in a request pertaining to a new product received by the reception section 201 and (ii) information indicating that the new product is more likely to have the property. A relation between a range of probability values predicted by the link prediction section 205 and a display of a level of possibility of expression may be defined in advance. For example, a probability value predicted to be equal to or more than 90% may be defined to indicate a high possibility of expression.

The basis information illustrated in FIG. 8 also includes presence or absence of a side effect in the new product and information indicating another property pertaining to the new product. Each of those properties is also associated with information indicating a possibility of expressing that property.

By outputting basis information as illustrated in FIG. 8 from the output section 210, it is possible to give a user a strong determination basis for determining whether or not the inferred production method is effective for imparting an intended property to a new product.

(Basis Generation with Respect to Link Prediction Result)

The basis generation section 209 can generate basis information also by analyzing a new product graph and an existing product graph. The following description will discuss a method of generating basis information by analyzing a new product graph and an existing product graph.

For example, the basis generation section 209 may mine one or more rules from the new product graph and the existing product graph using principal component analysis (PCA) reliability based on open-world assumption (OWA). The basis generation section 209 may generate basis information using one or more rules that have been mined. For example, a method described in the following literature can be applied to mining of a rule.

Luis Galarraga et. al, “Fast rule mining in ontological knowledge bases with AMIE +”, The VLDB Journal (2015) 24:707-730

For example, a rule to be processed by the basis generation section 209 is expressed by

$${B}_{1} ⋀ {B}_{2} ⋀ … ⋀ {B}_{n} ⇒ r ( x , y )$$

using Head r(x, y) and Body {B1, . . . , Bn}. This rule may also be expressed as

$$\vec{B} ⇒ r ( x , y )$$

using a vector representation. Here, Head r(x, y) is also called an atom.

As a condition of the mining process, the basis generation section 209 uses the following conditions to carry out the mining process:
Connected: all values (variables, entities) in a rule are shared between different atoms;
Closed: all variables in a rule appear two times or more; and
Not reflexive: a rule containing a reflective atom (such as r(x, x)) is not mined.

The basis generation section 209 may use a head coverage (hc) defined by

$$hc ( \vec{B} ⇒ r ( x , y ) ) \text{?} \frac{supp ( \vec{B} ⇒ r ( x , y ) )}{size ( r )}$$

$$\text{?} \text{indicates text missing or illegible when filed}$$

and PCA reliability defined by

$$\text{?} ( \vec{B} ⇒ r ( x , y ) ) \text{?} = \frac{supp ( \vec{B} ⇒ r ( x , y ) )}{\text{?} ( x , y ) : \text{?} : \vec{B} ⋀ r ( x , \text{?} )}$$

$$\text{?} \text{indicates text missing or illegible when filed}$$

to carry out the mining process. By using PCA reliability, it is possible to mine a rule with higher accuracy, as compared with a case of using standard reliability. Therefore, by using the above configuration, it is possible for the basis generation section 209 to generate highly reliable basis information.

For example, it is assumed that the basis generation section 209 has mined a rule that “element included in one production method can be applied to another production method” in two products that satisfy a condition of “having common classification and common node of principal component”. In this case, if the link prediction section 205 has predicted, as an element included in a production method for producing a new product, an element included in a production method for producing a certain existing product, the basis generation section 209 may generate, as a basis of the prediction, basis information indicating that the certain existing product and the new product “have common classification and common node of principal component”.

### (Flow of Process)

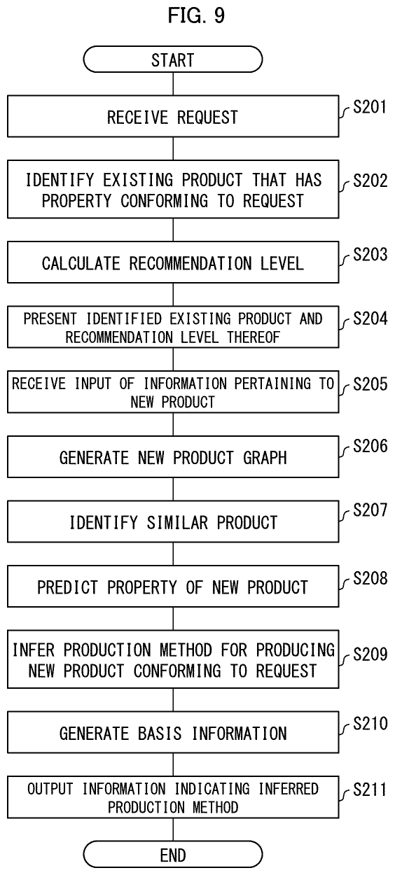

The following description will discuss a flow of a process (cosmetic production assistance method) carried out by the cosmetic production assistance apparatus 2, with reference to FIG. 9. FIG. 9 is a flowchart illustrating the flow of the process carried out by the cosmetic production assistance apparatus 2.

In S201, the reception section 201 receives a request pertaining to new cosmetic product development. In S201, for example, a request is received which indicates a property demanded of a new product, a part of raw materials used to produce the new product, and the like.

In S202, the existing product identification section 202 identifies, based on nodes and links included in an existing product graph, an existing product that has a property conforming to the request which has been received by the reception section 201. For example, in a case where the request received in S201 includes information indicating a property that is demanded of the new product, the existing product identification section 202 detects, from the existing product graph, a node and a link indicating the property, and identifies an existing product corresponding to the detected node and link.

In S203, the evaluation section 203 calculates a recommendation level of the existing product identified in S202. In a case where a plurality of existing products have been identified in S202, the evaluation section 203 calculates a recommendation level for each of the identified existing products.

In S204, the output section 210 outputs the existing product identified in S202 and the recommendation level calculated in S203 for the existing product, and thus presents the user with these pieces of information. For example, the output section 210 may present the user with an existing product and a recommendation level in an aspect as illustrated in FIG. 6.

In S205, the reception section 201 receives input of information pertaining to a new product which a user wants to produce. The information pertaining to the new product only needs to be information corresponding to a degree that a new product graph can be generated in the next S206. For example, as information pertaining to a new product, input of information indicating efficacy demanded of the new product, a raw material that has been decided to be used in the new product, and the like may be received.

In S205, the user can input raw materials, blending quantities, and a production method of a new product, with reference to the information presented in S204. For example, the user can refer to information as illustrated in FIG. 6 to identify a raw material and a production method used in an existing product that has efficacy which the user demands of a new product, and to input those items as a raw material and a production method to be applied to the new product.

In S206, the graph generation section 204 generates a new product graph based on the information input in S205. For example, in a case where input of efficacy demanded of a new product and a raw material used in the new product is received in S205, the graph generation section 204 may generate a new product graph including nodes and links indicating the efficacy and the raw material.

In S207, the link prediction section 205 carries out link prediction using the new product graph generated in S206 and an existing product graph which has learned in advance, and identifies a similar product, which is an existing product similar to the new product. The link prediction section 205 may identify a plurality of similar products. Here, the basis generation section 209 may generate basis information indicating a basis of an identification result by the link prediction section 205 by analyzing the new product graph and the existing product graph.

In S208, the property prediction section 207 predicts a property of the new product. Specifically, the property prediction section 207 predicts, as a property of the new product, a property of a similar product (which has been identified in S207) indicated in the existing product graph. In a case where a plurality of similar products have been identified in S207, a property of each of the similar products is predicted in S208.

In S209, the inference section 208 infers, based on the existing product graph which has learned in advance and the request received in S201, a production method for producing a new product conforming to the request. More specifically, the inference section 208 first identifies, with reference to the existing product graph, a production method for producing the similar product that has been identified in S207. Subsequently, the inference section 208 extracts some elements of the identified production method. At this time, the inference section 208 extracts some elements of a production method for producing the similar product which has the property predicted in S208 to conform to the request. Thus, it is possible to extract an element that may have been a factor based on which the similar product conforms to the request. Then, the inference section 208 infers a production method including the extracted element as a production method for producing a new product that conforms to the request.

In S210, the basis generation section 209 generates basis information indicating a basis of inference carried out in S209. For example, the basis generation section 209 may generate, as a basis of inference, basis information including information pertaining to an existing product which has efficacy identical with efficacy indicated in the request received in S201, i.e., efficacy demanded of a new product. This basis information may include information indicating a method for producing an existing product that has efficacy identical with efficacy demanded of a new product.

### Third Example Embodiment

### (Overview)

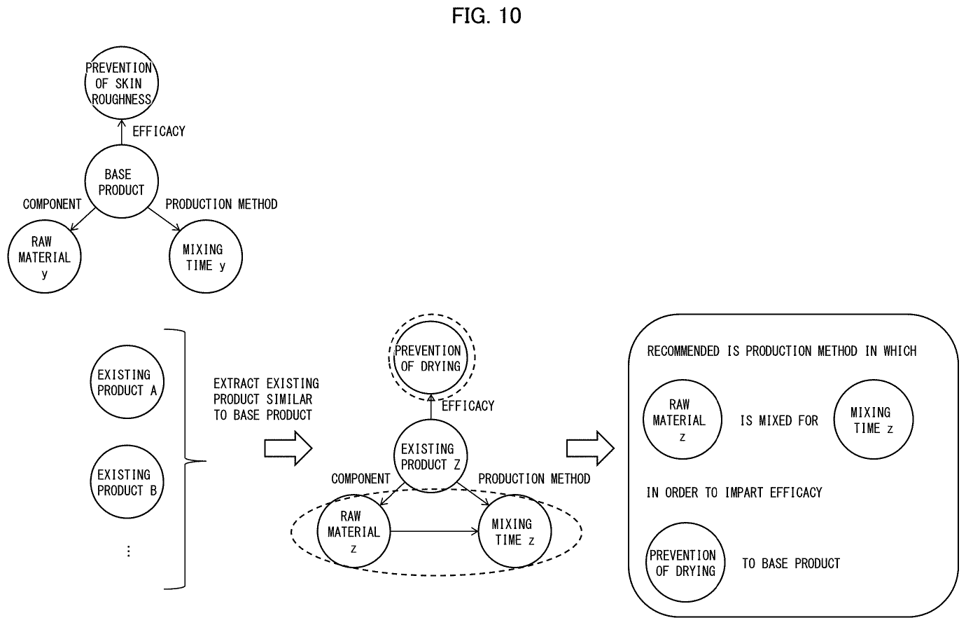

FIG. 10 is a diagram illustrating an overview of a cosmetic production assistance method in accordance with the present example embodiment. In the present example embodiment, an example will be described in which a base product graph and an existing product graph are used to assist cosmetic production. FIG. 10 illustrates nodes of an existing product A, an existing product B, and the like as nodes included in the existing product graph, and the other nodes included in the existing product graph are not illustrated. The existing product graph used in the present example embodiment is similar to that used in the second example embodiment (see FIG. 7).

A base product graph is a graph including a plurality of nodes pertaining to production of a base product, which serves as a base of a new product to be developed. The base product graph illustrated in FIG. 10 includes: a node indicating that the base product has efficacy of “prevention of skin roughness”; a node indicating that the base product contains a component “raw material y”; a node indicating that the base product is produced in a “mixing time y”; and links. Such a base product graph can be generated based on a component, efficacy, and a production method of the base product.

For example, it is possible to generate a base product graph by receiving, as a request from a user, input of a component, efficacy, and a production method of the base product. At this time, a request for efficacy or the like demanded of a new product on the basis of that base product may also be received. Alternatively, a user may select, as the base product, one of existing products indicated in the existing product graph. In this case, an existing product graph of the selected existing product may be used as a base product graph.

In the cosmetic production assistance method in accordance with the present example embodiment, an existing product having a predetermined relationship with the base product is identified by link prediction using the base product graph and the existing product graph, the link prediction being carried out for predicting a relationship between nodes which are not connected to each other by a link in the base product graph and the existing product graph. Then, based on a production method for producing the identified existing product, a production method for producing, while using the base product as a base, a new product that conforms to a request is inferred.

A production method for producing an existing product having a predetermined relationship with the base product is information useful for inferring a production method for producing a new product that is based on the base product and that conforms to a request. Therefore, according to the cosmetic production assistance method in accordance with the present example embodiment, it is possible to infer a production method for producing a new product conforming to a request, while taking into consideration the useful information.

According to the link prediction, it is possible to identify existing products that respectively have various relationships with the base product. For example, it is possible to identify an existing product similar to the base product. In addition, it is also possible to identify an existing product that is not similar to the base product, an existing product that belongs to the same classification as the base product, an existing product that has efficacy common to the base product, and the like.

FIG. 10 illustrates an example of identifying an existing product similar to the base product. Specifically, in the example of FIG. 10, among a plurality of existing products indicated in the existing product graph, an existing product Z is identified as an existing product similar to the base product, and an existing product graph of the existing product Z is extracted.

Here, the existing product graph of the existing product Z extracted as described above includes: a node indicating that the existing product Z has efficacy of “prevention of drying”; a node indicating that the existing product Z contains a component “raw material z”; a node indicating that the existing product Z is produced by mixing the “raw material z” in a “mixing time z”; and links. From these nodes, it can be seen that the existing product Z is similar to the base product but has the efficacy of prevention of drying, which is not in the base product. Then, it can be said that the efficacy may be derived from the production method in which the raw material z, which is a component not contained in the base product, is mixed for the mixing time z.

Based on the above facts, in the example of FIG. 10, a production method is recommended in which the raw material z is mixed for the mixing time z in order to add the efficacy of prevention of drying to the base product. Thus, according to the cosmetic production assistance method in accordance with the present example embodiment, it is possible to infer and recommend a production method for producing a new product conforming to a request from a user.

### (Apparatus Configuration)

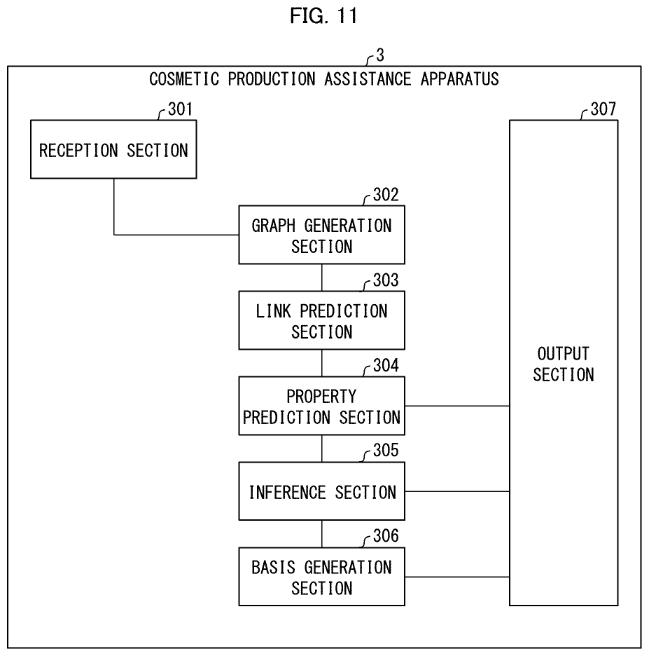

The following description will discuss a configuration of a cosmetic production assistance apparatus 3 in accordance with the third example embodiment of the present invention, with reference to FIG. 11. FIG. 11 is a block diagram illustrating the configuration of the cosmetic production assistance apparatus 3 in accordance with the present example embodiment.

As illustrated in FIG. 11, the cosmetic production assistance apparatus 3 includes a reception section 301, a graph generation section 302, a link prediction section 303, a property prediction section 304, an inference section 305, a basis generation section 306, and an output section 307. As with the cosmetic production assistance apparatus 2 in accordance with the second example embodiment, the cosmetic production assistance apparatus 3 may include, in addition to those constituent elements, a learning section, an input apparatus, an output apparatus, a communication apparatus, and the like.

The reception section 301 receives a request pertaining to new cosmetic product development. This request may include, for example, efficacy demanded of a new product, a raw material or a component to be used in a new product, a production method to be applied in production of a new product, and the like. The request may include, for example, information identifying a base product that serves as a base of the new product, and a component, efficacy, and a production method of such a base product.

The graph generation section 302 generates, based on the information pertaining to the base product described above, a base product graph representing the base product in the form of graph. Specifically, the graph generation section 302 generates a base product graph representing the base product with nodes each indicating a component, efficacy, or a production method of the base product, and edges each representing a relationship between the nodes. In a case where a base product graph is included in an existing product graph, the graph generation section 302 may extract the base product graph from the existing product graph.

The link prediction section 303 identifies an existing product similar to the base product by link prediction using the base product graph and the existing product graph, the link prediction being carried out for predicting a relationship between nodes which are not connected to each other by a link in the base product graph and the existing product graph. Hereinafter an existing product similar to the base product is referred to as a similar product of the base product. As described above, according to the link prediction, it is possible to identify an existing product having an arbitrary relationship with the base product, other than the relation of being similar.

The property prediction section 304 predicts a property that can be added to the base product. Specifically, the property prediction section 304 refers to an existing product graph of a similar product of the base product identified by the link prediction section 303, and predicts, among properties indicated in the existing product graph, a property which is not in the base product, as a property that can be added to the base product.

The inference section 305 infers a production method for producing a new product conforming to the request based on the request received by the reception section 301 and a learned model which has learned a relation between (i) a component and efficacy of an existing product and (ii) a method for producing the existing product. Specifically, the learned model is the foregoing existing product graph. As described above, the link prediction section 303 carries out link prediction using an existing product graph. Therefore, the inference section 305 carries out the above-described inference based on a result of link prediction by the link prediction section 303, and thereby carries out inference based on the learned model.

The basis generation section 306 generates basis information indicating a basis of inference carried out by the inference section 305. The basis generation section 306 is similar to the basis information generation section 209 in the second example embodiment, and therefore detailed descriptions thereof are not repeated.

The output section 307 outputs various kinds of information generated by the cosmetic production assistance apparatus 3, such as information indicating a production method inferred by the inference section 305. An output destination of the information is not particularly limited, as with the output section 210 in accordance with the second example embodiment.

As described above, the cosmetic production assistance apparatus 3 includes the link prediction section 303 for identifying, by link prediction using a base product graph and the existing product graph, an existing product having a predetermined relationship with a base product, the base product graph including a plurality of nodes pertaining to production of the base product serving as a base of a new product to be developed, and the link prediction being carried out for predicting a relationship between nodes which are not connected to each other by a link in the base product graph and the existing product graph. Then, based on a production method for producing the existing product identified by the link prediction section 303, the inference section 305 infers a production method for producing, while using the base product as a base, a new product that conforms to a request.

A production method for producing an existing product having a predetermined relationship with the base product is information useful for inferring a production method for producing a new product that is based on the base product and that conforms to a request. Therefore, according to the configuration, it is possible to infer a production method for producing a new product conforming to a request, while taking into consideration the useful information.

### (Flow of Process)

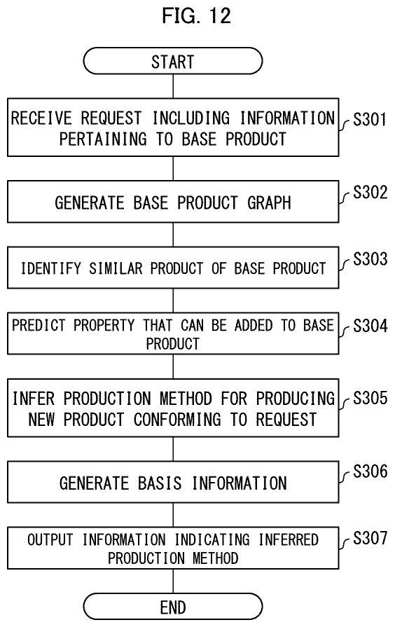

The following description will discuss a flow of a process (cosmetic production assistance method) carried out by the cosmetic production assistance apparatus 3, with reference to FIG. 12. FIG. 12 is a flowchart illustrating the flow of the process carried out by the cosmetic production assistance apparatus 3.

In S301, the reception section 301 receives a request pertaining to new cosmetic product development. Here, it is assumed that information pertaining to a base product is included in the received request. The information pertaining to the base product only needs to be information corresponding to a degree that a base product graph can be generated in the next S302. For example, information indicating a component, efficacy, a production method, and the like of the base product may be received as a request.

In S302, the graph generation section 302 generates a base product graph based on the information input in S301. For example, in S301, upon receipt of input of a component, efficacy, and a production method of the base product, the graph generation section 302 may generate a base product graph including nodes and links indicating the component, the efficacy, and the production method.

In S303, the link prediction section 303 carries out link prediction using an existing product graph which has learned in advance and the base product graph which has been generated in S302, and identifies a similar product of the base product. Here, the basis generation section 306 may generate basis information indicating a basis of an identification result by the link prediction section 303 by analyzing the base product graph and the existing product graph.

In S304, the property prediction section 304 predicts, based on an identification result in S303, a property that can be added to the base product. Specifically, the property prediction section 304 refers to an existing product graph of a similar product of the base product identified in S303, and predicts, among properties indicated in the existing product graph, a property which is not in the base product, as a property that can be added to the base product.

Here, the output section 307 may output and present, to a user, properties predicted by the property prediction section 304, and allow the user to select a property that is demanded of a new product from among the properties that are presented. In this case, the reception section 301 receives, as a request, a property selected by the user.

In a case where the request received in S301 includes efficacy demanded of a new product, the property prediction section 304 may determine, after the process of S304, whether or not the requested efficacy is included in the predicted properties. In a case where the property prediction section 304 has determined that the requested efficacy is not included, the output section 307 may output a message indicating that a production method for producing a new product having the requested efficacy could not be inferred, and the process of FIG. 12 may be ended.

In S305, the inference section 305 infers a production method for producing a new product that conforms to the request. Specifically, first, the inference section 305 refers to an existing product graph and identifies, among existing products that have been identified in S303 as being similar products of the base product, an existing product that has a property conforming to the request. Here, the request is a request received in S301 or a request based on a prediction result in S304. Here, the inference section 305 does not need to identify an existing product that has all of requested properties, and may identify an existing product that has at least one or some of the requested properties.

Then, the inference section 305 refers to an existing product graph of the identified existing product, and infers, as an element of a production method for producing a new product, an element that is not included in a production method for producing the base product, among elements that are included in a production method for producing the existing product. A production method including the element is an inference result of inferring a production method for producing a new product that conforms to the request.

In S306, the basis generation section 306 generates basis information indicating a basis of inference carried out in S306. Specifically, the basis generation section 306 may generate basis information including information pertaining to an existing product which has efficacy identical with efficacy that is demanded of a new product. This basis information may include information indicating a method for producing an existing product which has efficacy identical with efficacy that is demanded of a new product. For example, the basis generation section 306 may generate, as basis information, a product name of an existing product (an existing product that has a property conforming to the request among existing products that have been identified as being similar products of the base product) identified in S305, and a production method thereof indicated in the existing product graph.

In S307, the output section 307 outputs information indicating the production method which has been inferred in S305. At this time, the output section 307 may output also the basis information which has been generated in S306. Thus, the process of FIG. 12 ends.

As described above, the inference section 305 may infer, as an element of a production method for producing a new product, an element which is not included in a production method for producing a base product, among elements that are included in a production method for producing a similar product of the base product which has been identified by the link prediction section 303 in S303.

An element which is included in a production method for producing an existing product similar to the base product but which is not included in a method for producing the base product is more likely to be an element conforming to the method for producing the base product. Therefore, according to the configuration, it is possible to infer, as an element of a production method for producing a new product, an element that is highly likely to conform to the production method for producing the base product.

Various conditions can be set for link prediction in S303. For example, the link prediction section 303 may identify an existing product that is similar to the base product and has at least one property which is demanded of a new product. The property demanded of the new product may be identified based on the request received in S301.

Such information pertaining to an existing product is extremely useful in inference of a production method for producing a new product having the property. Therefore, according to the configuration, it is possible to accurately infer a production method for producing a cosmetic having an intended property. In a case where, in S303, the configuration is employed in which an existing product having a predetermined property is identified, the process of S304 may be omitted.

In S303, the link prediction section 303 may identify, by link prediction using the base product graph and the existing product graph, a production method for producing an existing product that is similar to the base product and that has a property conforming to the request. In this case, the inference section 305 may infer, as an element of a production method for producing a new product, an element included in the production method which has been identified in this manner. Even while omitting identification of a similar product, a relation of similarity between products is learned when training an existing product graph. Therefore, by the link prediction described above, it is possible to identify a production method for producing an existing product that has a property conforming to a request. In this case, the processes of S303 through S305 are omitted.

### Fourth Example Embodiment

### (Overview)

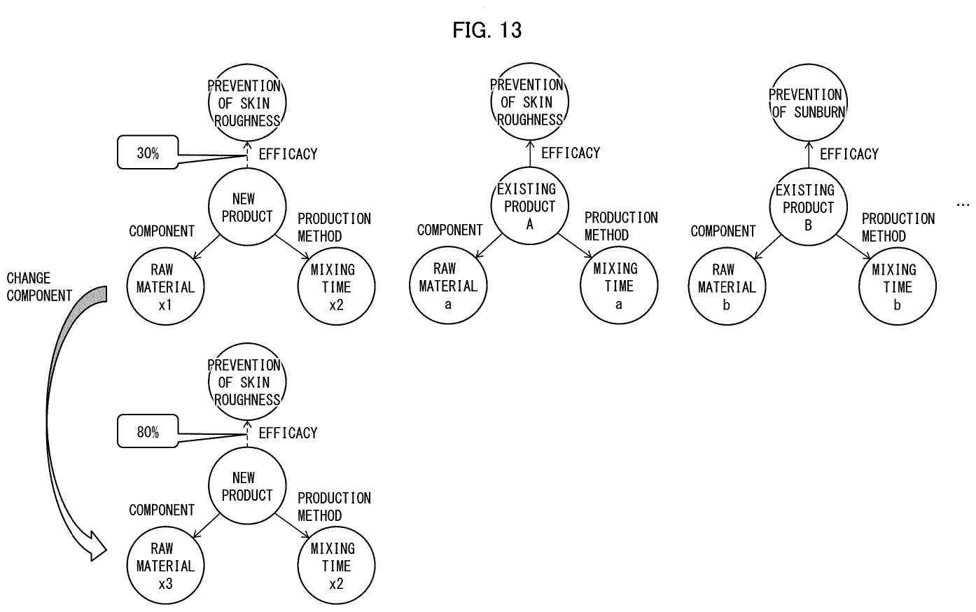

FIG. 13 is a diagram illustrating an overview of a cosmetic production assistance method in accordance with the present example embodiment. In the present example embodiment, an example will be described in which a production method for producing a new product conforming to a request is inferred while updating a new product graph.

In the present example embodiment, as in the second example embodiment, link prediction is carried out using a new product graph and existing product graphs. A new product graph indicated in the upper left part of FIG. 13 includes nodes and links indicating that a “raw material x1” is contained as a component of a new product, and a mixing time of raw materials in a production method for producing the new product is a “mixing time x2”.

An existing product graph indicated in the upper middle part of FIG. 13 includes nodes and links indicating that an existing product A has efficacy of “prevention of skin roughness”, that components of the existing product A include a “raw material a”, and that a mixing time of raw materials in a production method for producing the existing product A is a “mixing time a”. Similarly, an existing product graph indicated in the upper right part of FIG. 13 includes nodes and links indicating that an existing product B has efficacy of “prevention of sunburn”, that components of the existing product B include a “raw material b”, and that a mixing time of raw materials in a production method for producing the existing product B is a “mixing time b”.

By training the existing product graphs for various existing products as described above, it is possible to carry out link prediction for predicting what product is likely to have what efficacy. That is, in the cosmetic production assistance method in accordance with the present example embodiment, a tentative new product graph is generated, and a probability that a new product indicated in the tentative new product graph has the requested efficacy is predicted by link prediction.

For example, in the example of FIG. 13, it is predicted, in the upper left new product graph, that a probability that the node of “prevention of skin roughness” will be connected to the node of “new product” by the link of “efficacy” is 30%. This probability is not high enough.

Therefore, as illustrated in the lower left part of FIG. 13, a node connected to the node of “new product” by the link of “component” in the new product graph is changed from “raw material x1” to “raw material x3”, and link prediction is carried out again. Thus, a prediction result of the probability that the node of “prevention of skin roughness” will be connected to the node of “new product” by the link of “efficacy” is changed to 80%.

According to the cosmetic production assistance method in accordance with the present example embodiment, it is possible to recommend, based on a result of the above-described process, using the “raw material x3” as a measure for imparting efficacy of prevention of skin roughness to a new product. In the example of FIG. 13, the raw material is replaced. Note, however, that a raw material can also be added. It is possible to similarly recommend a production method for producing a new product conforming to a request.

### (Apparatus Configuration)

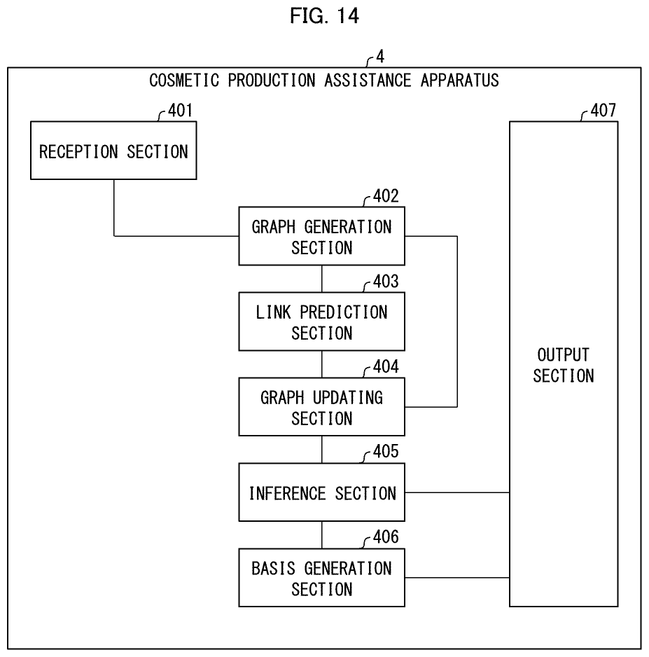

The following description will discuss a configuration of a cosmetic production assistance apparatus 4 in accordance with the fourth example embodiment of the present invention, with reference to FIG. 14. FIG. 14 is a block diagram illustrating the configuration of the cosmetic production assistance apparatus 4 in accordance with the present example embodiment.

As illustrated in FIG. 14, the cosmetic production assistance apparatus 4 includes a reception section 401, a graph generation section 402, a link prediction section 403, a graph updating section 404, an inference section 405, a basis generation section 406, and an output section 407. As with the cosmetic production assistance apparatus 2 in accordance with the second example embodiment, the cosmetic production assistance apparatus 4 may include, in addition to those constituent elements, a learning section, an input apparatus, an output apparatus, a communication apparatus, and the like.

The reception section 401 receives a request pertaining to new cosmetic product development. This request may include, for example, efficacy demanded of a new product, a raw material or a component to be used in a new product, a production method to be applied in production of a new product, and the like. The request may include, for example, a threshold of a probability that demanded efficacy is expressed in a new product.

The graph generation section 402 generates, based on information pertaining to a new product which a user wants to produce, a new product graph representing that new product in the form of graph, as with the graph generation section 204 in accordance with the second example embodiment.

The link prediction section 403 calculates, by link prediction using the new product graph and the existing product graph, a probability that a node indicating a property that conforms to the request links to a node included in the new product graph, the link prediction being carried out for predicting a relationship between nodes which are not connected to each other by a link in the new product graph and the existing product graph.

The graph updating section 404 updates the new product graph. Specifically, the graph updating section 404 carries out one or both of a process of replacing a node included in the new product graph with another node and a process of adding a new node to the new product graph.

The updating of the new product graph may be carried out according to input by a user or may be carried out automatically. In the former case, the graph updating section 404 may cause the output section 407 to output a list including nodes included in the current new product graph and nodes that serve as candidates to be added to the new product graph or replaced with nodes in the current new product graph. In the latter case, the graph updating section 404 may select a node to be added from among such candidates. A candidate node may be extracted from an existing product graph of an existing product having the requested property.

The inference section 405 infers a production method for producing a new product conforming to the request based on the request received by the reception section 401 and a learned model which has learned a relation between (i) a component and efficacy of an existing product and (ii) a method for producing the existing product. Specifically, the learned model is the foregoing existing product graph. As described above, the link prediction section 403 carries out link prediction using an existing product graph. Therefore, the inference section 405 carries out the above-described inference based on a result of link prediction by the link prediction section 403, and thereby carries out inference based on the learned model.

The basis generation section 406 generates basis information indicating a basis of inference carried out by the inference section 405. The basis generation section 406 is similar to the basis information generation section 209 in the second example embodiment, and therefore detailed descriptions thereof are not repeated.

The output section 407 outputs various kinds of information generated by the cosmetic production assistance apparatus 3, such as information indicating a production method inferred by the inference section 405. An output destination of the information is not particularly limited, as with the output section 210 in accordance with the second example embodiment.

As described above, the cosmetic production assistance apparatus 4 includes the link prediction section 403 for calculating, by link prediction using a new product graph and the existing product graph, a probability that a node indicating a property that conforms to the request links to a node included in the new product graph, the new product graph including a plurality of nodes pertaining to production of a new product to be developed, and the link prediction being carried out for predicting a relationship between nodes which are not connected to each other by a link in the new product graph and the existing product graph, and the inference section 405 infers a production method for producing a new product conforming to the request on the basis of the probability which has been calculated by the link prediction section 403.

A probability that a node indicating a property conforming to the request links to a node included in the new product graph can be said to indicate a possibility that the new product has a property conforming to the request. Therefore, according to the configuration in which a production method for producing a new product is inferred based on the probability, it is possible to infer a production method that imparts, to a new product, a property conforming to a request.

### (Flow of Process)

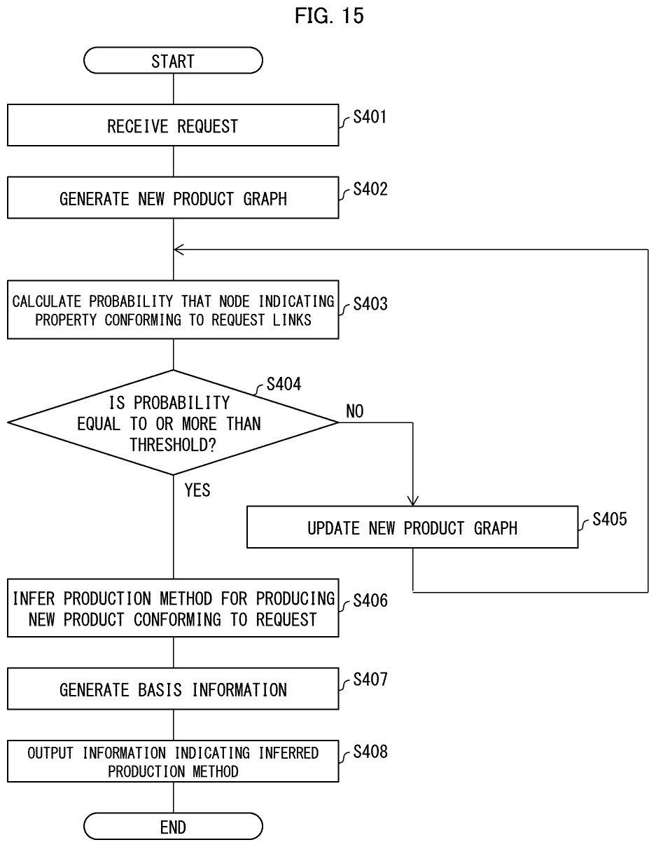

The following description will discuss a flow of a process (cosmetic production assistance method) carried out by the cosmetic production assistance apparatus 4, with reference to FIG. 15. FIG. 15 is a flowchart illustrating the flow of the process carried out by the cosmetic production assistance apparatus 4.

In S401, the reception section 401 receives a request pertaining to new cosmetic product development. In S401, for example, a request is received which indicates a property demanded of a new product, a part of raw materials used to produce the new product, and the like.

In S402, the graph generation section 402 generates a new product graph based on the information input in S401. For example, in a case where input of efficacy demanded of a new product and one of raw materials used in production of the new product is received in S401, the graph generation section 402 may generate a new product graph including nodes and links indicating the efficacy and the raw material.

In S403, the link prediction section 403 calculates a probability that a node indicating a property that conforms to the request received in S401 links to a node included in the new product graph generated in S402. As described above, calculation of the probability is carried out by link prediction using a learned existing product graph(s) and the new product graph. Here, the basis generation section 406 may generate basis information indicating a basis of a calculation result by the link prediction section 403 by analyzing the new product graph and the existing product graph(s).

In S404, the graph updating section 404 determines whether or not the probability calculated in S403 is equal to or more than a threshold. If it has been determined that the probability is equal to or more than the threshold (YES in S404), the process proceeds to S406. If it has been determined that the probability is less than the threshold (NO in S404), the process proceeds to S405.

In a case where a plurality of properties are indicated in the request received in S401, prediction is carried out for each of the properties in S403. Then, in S404, the determination may be YES if probabilities for all of the properties are equal to or more than the threshold, and the determination may be NO if any one of the probabilities is less than the threshold. Thus, it is possible to infer a production method for producing a new product that satisfies all of the requested properties.

The request may indicate that a product does not have a predetermined property such as, for example, “no side effect”. In this case, in S403, a probability that a node of the property links may be calculated, and in S404, whether or not the probability is equal to or less than a threshold may be determined.

In S405, the graph updating section 404 updates the new product graph. Specifically, the graph updating section 404 may replace a node included in the current new product graph with another node, or may add a new node and a new link to the current new product graph. The update content may be decided according to input by a user, or may be decided by the graph updating section 404, as described above.

When the new product graph has been updated, the process returns to S403, and calculation of a probability is carried out again. That is, in the process of FIG. 15, until it is determined to be YES in S404, calculation of a probability in S403 and updating of the new product graph in S405 are repeatedly carried out.

In S406, the inference section 405 infers a production method for producing a new product that conforms to the request received in S401. Specifically, the inference section 405 infers that a production method which is indicated in the new product graph at the time when it is determined to be YES in S404 is a production method for producing a new product that conforms to the request.

In S407, the basis generation section 406 generates basis information indicating a basis of inference carried out in S406. Specifically, the basis generation section 406 may generate basis information including information pertaining to an existing product which has efficacy identical with efficacy that is demanded of a new product. This basis information may include information indicating a method for producing an existing product which has efficacy identical with efficacy that is demanded of a new product.

In S408, the output section 407 outputs information indicating the production method which has been inferred in S406. At this time, the output section 407 may output also the basis information which has been generated in S407. Thus, the process of FIG. 15 ends.

### Fifth Example Embodiment

### (Overview)

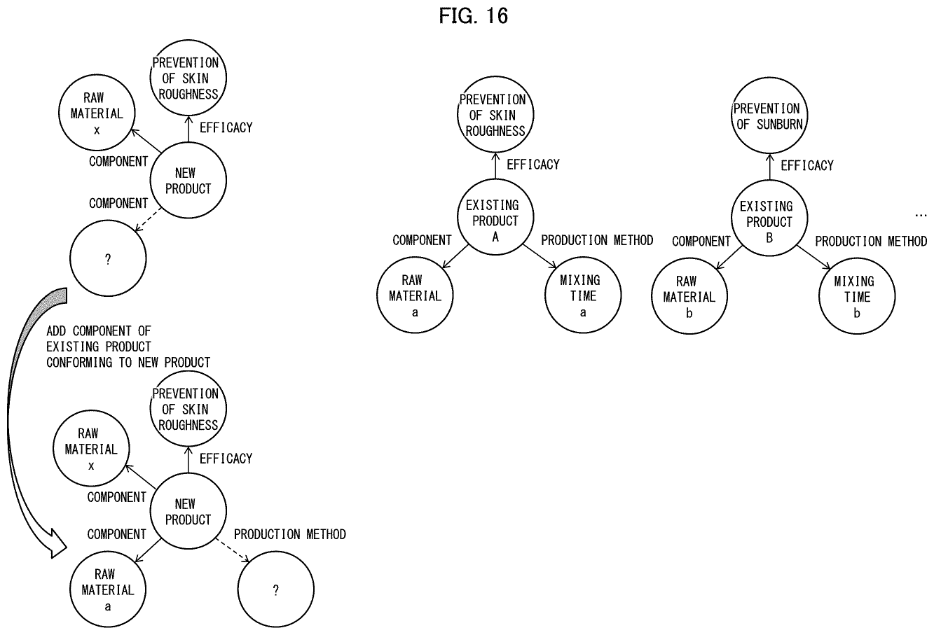

FIG. 16 is a diagram illustrating an overview of a cosmetic production assistance method in accordance with the present example embodiment. In the present example embodiment, an example will be described in which a production method for producing a new product conforming to a request is inferred while sequentially adding nodes indicating components and a production method to a new product graph.

In the present example embodiment, as in the second example embodiment, link prediction is carried out using a new product graph and existing product graphs. A new product graph indicated in the upper left part of FIG. 16 includes nodes and links indicating that a “raw material x1” is included in components of a new product and that efficacy of “prevention of skin roughness” is demanded of the new product.

An existing product graph indicated in the upper middle part of FIG. 16 includes nodes and links indicating that an existing product A has efficacy of “prevention of skin roughness”, that components of the existing product A include a “raw material a”, and that a mixing time of raw materials in a production method for producing the existing product A is a “mixing time a”. Similarly, an existing product graph indicated in the upper right part of FIG. 13 includes nodes and links indicating that an existing product B has efficacy of “prevention of sunburn”, that components of the existing product B include a “raw material b”, and that a mixing time of raw materials in a production method for producing the existing product B is a “mixing time b”.

By training existing product graphs for various existing products as described above, it is possible to carry out link prediction for predicting what component and what production method are likely to be applied to what product. That is, in the cosmetic production assistance method in accordance with the present example embodiment, a component or a production method that is likely to be applied to a new product is predicted by link prediction, and a node is added to the new product graph based on the prediction result, so that a production method for producing the new product is inferred.

For example, in the example of FIG. 16, a node connected to a node of “new product” by a link of “component” in the new product graph indicated in the upper left part is predicted by link prediction. Then, as illustrated in the lower left part, the node is added to the new product graph based on the fact that, by the link prediction, the node connected to the node of “new product” by the link of “component” has been predicted to be a “raw material a”.

After deciding a component of the new product in this manner, a node connected to the node of “new product” by a link of “production method” in the new product graph, to which the node has been added, is predicted by link prediction. Thus, it is possible to predict a production method while taking into consideration the node indicating the component, which has been added based on the result of link prediction.

According to the cosmetic production assistance method in accordance with the present example embodiment, it is possible to sequentially predict, by repeating the above-described process, a component and a production method for imparting efficacy of prevention of skin roughness to a new product, and recommend a production method including the predicted components and the predicted production method.

### (Apparatus Configuration)

A configuration of a cosmetic production assistance apparatus in accordance with the fifth example embodiment of the present invention is similar to the configuration of the cosmetic production assistance apparatus 4 illustrated in FIG. 14. The difference is in contents of processes which are carried out by the link prediction section 403 and the inference section 405.

Specifically, in the cosmetic production assistance apparatus in accordance with the fifth example embodiment, the link prediction section 403 predicts, by link prediction using an existing product graph and a new product graph including a plurality of nodes pertaining to production of a new product to be developed, a node that links to a node included in the new product graph from among nodes that are included in the existing product graph and that indicate a production method for producing an existing product, the link prediction being carried out for predicting a relationship between nodes which are not connected to each other by a link in the new product graph and the existing product graph. Then, based on the node predicted by the link prediction section, the inference section 405 infers production method for producing a new product that conforms to a request.

Among nodes indicating a production method for producing an existing product, it can be said that a node linked to a new product graph indicates a production method that is more likely to conform to a production method for producing a new product. Therefore, according to the configuration in which a production method for producing a new product is inferred based on such a node, it is possible to infer a production method that is more likely to conform to the new product.

### (Flow of Process)

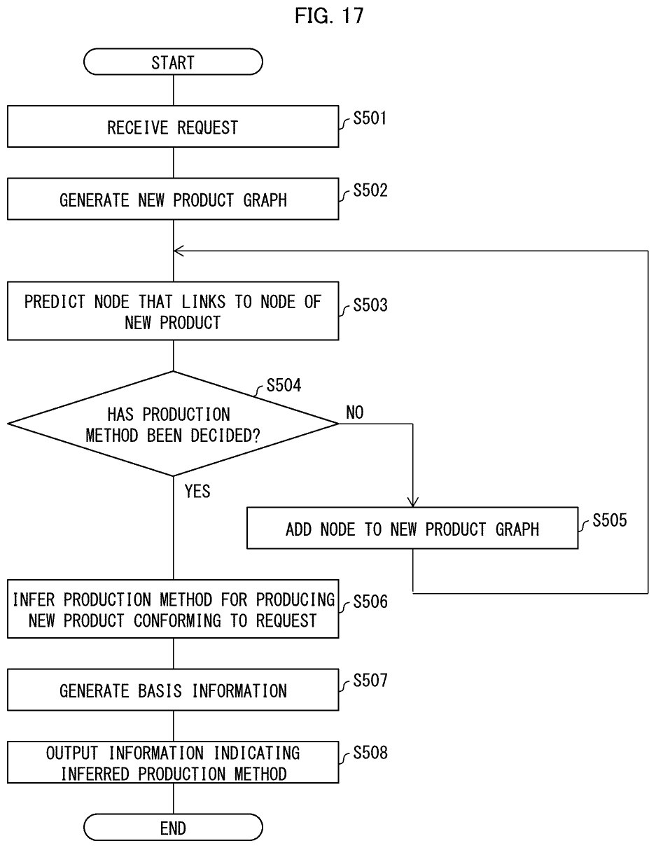

The following description will discuss a flow of a process (cosmetic production assistance method) carried out by the cosmetic production assistance apparatus in accordance with the fifth example embodiment of the present invention, with reference to FIG. 17. FIG. 17 is a flowchart illustrating a flow of a process carried out by the cosmetic production assistance apparatus in accordance with the fifth example embodiment of the present invention. In the descriptions below, execution subjects of processes are the reception section 401 through the output section 407 (see FIG. 14), as with the fourth example embodiment.

In S501, the reception section 401 receives a request pertaining to new cosmetic product development. In S401, for example, a request is received which indicates a property demanded of a new product, a part of raw materials used to produce the new product, and the like.

In S502, the graph generation section 402 generates a new product graph based on the information input in S501. For example, in a case where input of efficacy demanded of a new product and one of raw materials used in production of the new product is received in S401, the graph generation section 402 may generate a new product graph including nodes and links indicating the efficacy and the raw material.

In S502, by generating a new product graph of a new product that conforms to all of properties indicated in the request received in S501, it is possible to infer a production method for producing that new product. The new product graph at this stage only needs to include nodes and links indicating that the new product conforms to the properties.

In S503, the link prediction section 403 predicts a node that links to a node included in the new product graph generated in S502. As described above, the node is predicted by link prediction using the learned existing product graph(s) and the new product graph. Here, the basis generation section 406 may generate basis information indicating a basis of a prediction result by the link prediction section 403 by analyzing the new product graph and the existing product graph(s).

In S503, the link prediction section 403 may predict a node connected to a node of “new product” by a link of “component” or “production method”. Alternatively, the link prediction section 403 may predict a node connected to a node indicating a component or a node indicating a production method. For example, a node connected to a node indicating a component by a link of “blending quantity” may be predicted, or a node connected to a node indicating a mixing time by a link of “mixing rate” may be predicted. Thus, it is possible to infer details of components and a production method of a new product.

In S504, the graph updating section 404 determines whether or not to decide a production method for producing a new product. If it has been determined that a decision is made at this point (YES in S504), the process proceeds to S506. If it has been determined that a decision is not made at this point (NO in S504), the process proceeds to S505.

A condition for deciding a production method in S504 may be set in advance. For example, a threshold of the number of nodes indicating components and a threshold of the number of nodes indicating production methods may be set in advance, and a production method may be decided when the numbers of those nodes included in a new product graph are both equal to or more than the thresholds. Alternatively, for example, whether or not to decide a production method may be decided according to input by a user. In this case, it is preferable that the output section 407 outputs a new product graph or a component and a production method indicated in the new product graph so as to present the information to a user.

In S505, the graph updating section 404 adds a node and a link to the new product graph. The link and the node to be added may be decided according to input by a user, or may be decided by the graph updating section 404. In S505, the graph updating section 404 may replace, according to input by a user, a node included in the current new product graph with another node.

When the new product graph has been thus updated by adding the node and the link, the process returns to S503, and a node that links to a node included in the updated new product graph is predicted. That is, in the process of FIG. 17, until it is determined to be YES in S504, prediction of a node in S503 and updating of the new product graph are repeatedly carried out. The processes of S506 through S508 are similar to the processes of S406 through S408 of FIG. 15.

### [Variation]

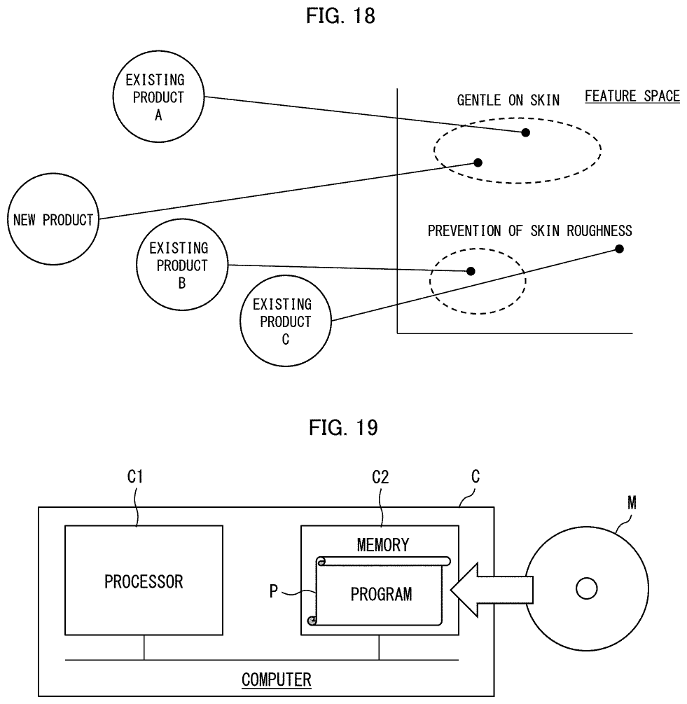

As described above, by using a new product graph and an existing product graph, it is possible to predict, by link prediction, a property of a new product indicated in the new product graph. Prediction of a property of the new product can also be carried out by a method other than link prediction. This will be described with reference to FIG. 18. FIG. 18 is a diagram illustrating an example of predicting a property of a new product based on a feature quantity calculated from a new product graph and an existing product graph. FIG. 18 shows existing product graphs of existing products A through C and a new product graph of a new product. Note that nodes and links included in these graphs are not illustrated.

Here, it is possible to calculate a feature quantity for each existing product by multiplying a feature quantity of each node included in the existing product graph by a weight corresponding to a link connected to that node, and adding up the weighted feature quantities. Therefore, by carrying out learning in which the weight is updated so that a calculated feature quantity corresponds to a property of the existing product, it is possible to predict a property of a new product from a feature quantity of a new product graph which has been calculated while applying the weight.

For example, in the example of FIG. 18, a feature quantity calculated from the existing product graph of the existing product A that has been found to be gentle on the skin is learned to fall within a range corresponding to a property of “gentle on skin” in a feature space. Moreover, a feature quantity calculated from the existing product graph of the existing product B that has been found to have efficacy of prevention of skin roughness is learned to fall within a range corresponding to a property “prevention of skin roughness” in the feature space.

In this case, if a feature quantity calculated from the new product graph is included within the range corresponding to the property “gentle on skin” as illustrated in FIG. 18, it is possible to predict that the new product has the property “gentle on skin”. Such a property prediction method can be applied as an alternative method to the method of property prediction in the above-described example embodiments.

### Software Implementation Example

Some or all of the functions of each of the cosmetic production assistance apparatuses 1 through 4 and the cosmetic production assistance apparatus in accordance with the fifth example embodiment (hereinafter, referred to as “present apparatus”) may be implemented by hardware such as an integrated circuit (IC chip), or may be implemented by software.

In the latter case, the present apparatus is realized by, for example, a computer that executes instructions of a program that is software realizing the foregoing functions. FIG. 19 illustrates an example of such a computer (hereinafter, referred to as “computer C”). The computer C includes at least one processor C1 and at least one memory C2. The memory C2 stores a program (cosmetic production assistance program) P for causing the computer C to function as the present apparatus. In the computer C, the processor C1 reads the program P from the memory C2 and executes the program P, so that the functions of the present apparatus are realized.

Examples of the processor C1 include a central processing unit (CPU), a graphic processing unit (GPU), a digital signal processor (DSP), a micro processing unit (MPU), a floating point number processing unit (FPU), a physics processing unit (PPU), a microcontroller, and a combination thereof. Examples of the memory C2 include a flash memory, a hard disk drive (HDD), a solid state drive (SSD), and a combination thereof.

Note that the computer C can further include a random access memory (RAM) in which the program P is loaded when the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a computer C-readable, non-transitory, and tangible storage medium M. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communication network, a broadcast wave, or the like. The computer C can obtain the program P also via such a transmission medium.

### [Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

Some or all of the foregoing example embodiments can also be described as below. Note, however, that the present invention is not limited to the following supplementary notes.

### (Supplementary Note 1)

A cosmetic production assistance apparatus, including: a reception means for receiving a request pertaining to new cosmetic product development; an inference means for inferring a production method for producing a new product conforming to the request based on the request and a learned model which has learned a relation between (i) a component and efficacy of an existing product, which is an existing cosmetic product, and (ii) a method for producing the existing product; and an output means for outputting information indicating the production method which has been inferred by the inference means. According to the configuration, it is possible to bring about an example advantage of suitably assisting new cosmetic product development.

### (Supplementary Note 2)

The cosmetic production assistance apparatus according to supplementary note 1, in which: the request includes information indicating efficacy that is demanded of the new product; the cosmetic production assistance apparatus further includes a basis generation means for generating, as a basis of inference, basis information including information pertaining to an existing product which has efficacy identical with the efficacy that is demanded of the new product; and the output means further outputs the basis information. According to the configuration, it is possible to give a user a strong determination basis for determining whether or not the inferred production method is effective for imparting intended efficacy to a new product.

### (Supplementary Note 3)

The cosmetic production assistance apparatus according to supplementary note 2, in which: the basis information includes information indicating a method for producing the existing product which has efficacy identical with the efficacy that is demanded of the new product. According to the configuration, it is possible to give a user a strong determination basis for determining whether or not the inferred production method is effective for imparting intended efficacy to a new product.

### (Supplementary Note 4)

The cosmetic production assistance apparatus according to supplementary note 1, in which: the learned model is an existing product graph in which one or more existing products are represented by nodes each indicating a component, efficacy, or a production method of each of the one or more existing products and edges each indicating a relationship between the nodes. According to the configuration, it is possible to infer a proper production method while taking into consideration a mutual relationship between a component, efficacy, and a production method of an existing product.

### (Supplementary Note 5)

The cosmetic production assistance apparatus according to supplementary note 4, in which: the request includes information indicating efficacy that is demanded of the new product; and the inference means infers, as a production method for producing a new product having the efficacy, a production method that includes at least one of elements of an existing product production method that correspond to a node and a link which are included in the existing product graph and which indicate the efficacy. According to the configuration, it is possible to infer a production method for producing a new cosmetic product having intended efficacy.

### (Supplementary Note 6)

The cosmetic production assistance apparatus according to supplementary note 4, further including: a link prediction means for identifying, by link prediction using a new product graph and the existing product graph, an existing product having a predetermined relationship with a new product, the new product graph including a plurality of nodes pertaining to production of the new product to be developed, and the link prediction being carried out for predicting a relationship between nodes which are not connected to each other by a link in the new product graph and the existing product graph, the inference means inferring a production method for producing a new product conforming to the request on the basis of a method for producing the existing product which has been identified by the link prediction means. According to the configuration, it is possible to infer a production method for producing a new product conforming to a request, while taking into consideration the useful information.

### (Supplementary Note 7)

The cosmetic production assistance apparatus according to supplementary note 6, further including: an existing product identification means for identifying, based on the nodes and the links included in the existing product graph, an existing product that has a property conforming to the request. According to the configuration, it is possible to infer a production method for producing a new product conforming to a request, while taking into consideration the useful information.

### (Supplementary Note 8)

The cosmetic production assistance apparatus, according to supplementary note 6 or 7, in which: the link prediction means identifies, by the link prediction, an existing product which is similar to the new product; and the cosmetic production assistance apparatus further includes a property prediction means for predicting, as a property of the new product, a property of the existing product which has been identified by the link prediction means, the property of the existing product being indicated in the existing product graph. According to the configuration, it is possible to predict a proper property as a property of a new product.

### (Supplementary Note 9)

The cosmetic production assistance apparatus according to supplementary note 4, further including: a link prediction means for identifying, by link prediction using a base product graph and the existing product graph, an existing product having a predetermined relationship with a base product, the base product graph including a plurality of nodes pertaining to production of the base product serving as a base of a new product to be developed, and the link prediction being carried out for predicting a relationship between nodes which are not connected to each other by a link in the base product graph and the existing product graph, the inference means inferring a production method for producing a new product which is based on the base product and which conforms to the request, on the basis of a method for producing the existing product which has been identified by the link prediction means. According to the configuration, it is possible to infer a production method for producing a new product conforming to a request, while taking into consideration the useful information.

### (Supplementary Note 10)

The cosmetic production assistance apparatus according to supplementary note 9, in which: the link prediction means identifies an existing product which is similar to the base product and has at least one property that is demanded of the new product. According to the configuration, it is possible to accurately infer a production method for producing a cosmetic having an intended property.

### (Supplementary Note 11)

The cosmetic production assistance apparatus according to supplementary note 9 or 10, in which: the inference means infers, as an element of a production method for producing the new product, an element which is not included in a production method for producing the base product, among elements that are included in a production method for producing the existing product which has been identified by the link prediction means. According to the configuration, it is possible to infer, as an element of a production method for producing a new product, an element that is highly likely to conform to the production method for producing the base product.

### (Supplementary Note 12)

The cosmetic production assistance apparatus according to supplementary note 4, further including: a link prediction means for calculating, by link prediction using a new product graph and the existing product graph, a probability that a node indicating a property that conforms to the request links to a node included in the new product graph, the new product graph including a plurality of nodes pertaining to production of a new product to be developed, and the link prediction being carried out for predicting a relationship between nodes which are not connected to each other by a link in the new product graph and the existing product graph, the inference means inferring a production method for producing a new product conforming to the request on the basis of the probability which has been calculated by the link prediction means. According to the configuration, it is possible to infer a production method that imparts, to a new product, a property conforming to a request.

### (Supplementary Note 13)

The cosmetic production assistance apparatus according to supplementary note 4, further including: a link prediction means for predicting, by link prediction using the learned model including a new product graph and the existing product graph, a node which is to link to the new product graph from among nodes which are included in the existing product graph and which indicate a production method for producing the existing product, the new product graph including a plurality of nodes pertaining to production of a new product to be developed, and the link prediction being carried out for predicting a relationship between nodes which are not connected to each other by a link in the new product graph and the existing product graph, the inference means inferring a production method for producing a new product conforming to the request on the basis of the node which has been predicted by the link prediction means. According to the configuration, it is possible to infer a production method that is highly likely to conform to a new product.

### (Supplementary Note 14)

A cosmetic production assistance method, including: receiving, by a computer, a request pertaining to new cosmetic product development; inferring, by the computer, a production method for producing a new product conforming to the request based on the request and a learned model which has learned a relation between (i) a component and efficacy of an existing product, which is an existing cosmetic product, and (ii) a method for producing the existing product; and outputting, by the computer, information indicating the production method which has been inferred. According to the configuration, it is possible to bring about an example advantage of suitably assisting new cosmetic product development.

### (Supplementary Note 15)

A cosmetic production assistance program for causing a computer to carry out: a process of receiving a request pertaining to new cosmetic product development; a process of inferring a production method for producing a new product conforming to the request based on the request and a learned model which has learned a relation between (i) a component and efficacy of an existing product, which is an existing cosmetic product, and (ii) a method for producing the existing product; and a process of outputting information indicating the production method which has been inferred. According to the configuration, it is possible to bring about an example advantage of suitably assisting new cosmetic product development.

### [Additional Remark 3]

Furthermore, some of or all of the foregoing example embodiments can also be expressed as below.

A cosmetic production assistance apparatus including at least one processor, the at least one processor carrying out: a process of receiving a request pertaining to new cosmetic product development; a process of inferring a production method for producing a new product conforming to the request based on the request and a learned model which has learned a relation between (i) a component and efficacy of an existing product, which is an existing cosmetic product, and (ii) a method for producing the existing product; and a process of outputting information indicating the production method which has been inferred.

The cosmetic production assistance apparatus may further includes a memory. The memory may store a program (cosmetic production assistance program) for causing the at least one processor to carry out: a process of receiving a request pertaining to new cosmetic product development; a process of inferring a production method for producing a new product conforming to the request based on the request and a learned model which has learned a relation between (i) a component and efficacy of an existing product, which is an existing cosmetic product, and (ii) a method for producing the existing product; and a process of outputting information indicating the production method which has been inferred. The program can be stored in a computer-readable non-transitory tangible storage medium.

### REFERENCE SIGNS LIST

1: Cosmetic production assistance apparatus
11: Reception section
12: Inference section
13: Output section
2: Cosmetic production assistance apparatus
201: Reception section
202: Existing product identification section
203: Evaluation section
205: Link prediction section
207: Property prediction section
208: Inference section
209: Basis generation section
210: Output section
3: Cosmetic production assistance apparatus
301: Reception section
303: Link prediction section
304: Property prediction section
305: Inference section
306: Basis generation section
307: Output section
4: Cosmetic production assistance apparatus
401: Reception section
403: Link prediction section
405: Inference section
406: Basis generation section
407: Output section

What is claimed is:

1. A cosmetic production assistance apparatus, comprising at least one processor, the at least one processor carrying out:
a reception process of receiving a request pertaining to new cosmetic product development;
an inference process of inferring a production method for producing a new product conforming to the request based on the request and a learned model which has learned a relation between (i) a component and efficacy of an existing product, which is an existing cosmetic product, and (ii) a method for producing the existing product; and
an output process of outputting information indicating the production method which has been inferred in the inference process.

2. The cosmetic production assistance apparatus according to claim 1, wherein:
the request includes information indicating efficacy that is demanded of the new product;
the at least one processor further carries out a basis generation process of generating, as a basis of inference, basis information including information pertaining to an existing product which has efficacy identical with the efficacy that is demanded of the new product; and
in the output process, the at least one processor further outputs the basis information.

3. The cosmetic production assistance apparatus according to claim 2, wherein:
the basis information includes information indicating a method for producing the existing product which has efficacy identical with the efficacy that is demanded of the new product.

4. The cosmetic production assistance apparatus according to claim 1, wherein:
the learned model is an existing product graph in which one or more existing products are represented by nodes each indicating a component, efficacy, or a production method of each of the one or more existing products and edges each indicating a relationship between the nodes.

5. The cosmetic production assistance apparatus according to claim 4, wherein:
the request includes information indicating efficacy that is demanded of the new product; and
in the inference process, the at least one processor infers, as a production method for producing a new product having the efficacy, a production method that includes at least one of elements of an existing product production method that correspond to a node and a link which are included in the existing product graph and which indicate the efficacy.

6. The cosmetic production assistance apparatus according to claim 4, wherein:
the at least one processor further carries out a link prediction process of identifying, by link prediction using a new product graph and the existing product graph, an existing product having a predetermined relationship with a new product, the new product graph including a plurality of nodes pertaining to production of the new product to be developed, and the link prediction being carried out for predicting a relationship between nodes which are not connected to each other by a link in the new product graph and the existing product graph; and
in the inference process, the at least one processor infers a production method for producing a new product conforming to the request on the basis of a method for producing the existing product which has been identified in the link prediction process.

7. The cosmetic production assistance apparatus according to claim 6, wherein:
the at least one processor further carries out an existing product identification process of identifying, based on the nodes and the links included in the existing product graph, an existing product that has a property conforming to the request.

8. The cosmetic production assistance apparatus, according to claim 6, wherein:
in the link prediction process, the at least one processor identifies, by the link prediction, an existing product which is similar to the new product; and
the at least one processor further carries out a property prediction process of predicting, as a property of the new product, a property of the existing product which has been identified by in the link prediction process, the property of the existing product being indicated in the existing product graph.

9. The cosmetic production assistance apparatus according to claim 4, wherein:
the at least one processor further carries out a link prediction process of identifying, by link prediction using a base product graph and the existing product graph, an existing product having a predetermined relationship with a base product, the base product graph including a plurality of nodes pertaining to production of the base product serving as a base of a new product to be developed, and the link prediction being carried out for predicting a relationship between nodes which are not connected to each other by a link in the base product graph and the existing product graph; and
in the inference process, the at least one processor infers a production method for producing a new product which is based on the base product and which conforms to the request, on the basis of a method for producing the existing product which has been identified in the link prediction process.

10. The cosmetic production assistance apparatus according to claim 9, wherein:
in the link prediction process, the at least one processor identifies an existing product which is similar to the base product and has at least one property that is demanded of the new product.

11. The cosmetic production assistance apparatus according to claim 9, wherein:
in the inference process, the at least one processor infers, as an element of a production method for producing the new product, an element which is not included in a production method for producing the base product, among elements that are included in a production method for producing the existing product which has been identified in the link prediction process.

12. The cosmetic production assistance apparatus according to claim 4, wherein:
the at least one processor further carries out a link prediction process of calculating, by link prediction using a new product graph and the existing product graph, a probability that a node indicating a property that conforms to the request links to a node included in the new product graph, the new product graph including a plurality of nodes pertaining to production of a new product to be developed, and the link prediction being carried out for predicting a relationship between nodes which are not connected to each other by a link in the new product graph and the existing product graph; and
in the inference process, the at least one processor infers a production method for producing a new product conforming to the request on the basis of the probability which has been calculated in the link prediction process.

13. The cosmetic production assistance apparatus according to claim 4, wherein:
the at least one processor further carries out a link prediction process of predicting, by link prediction using the learned model including a new product graph and the existing product graph, a node which is to link to the new product graph from among nodes which are included in the existing product graph and which indicate a production method for producing the existing product, the new product graph including a plurality of nodes pertaining to production of a new product to be developed, and the link prediction being carried out for predicting a relationship between nodes which are not connected to each other by a link in the new product graph and the existing product graph; and
in the inference process, the at least one processor infers a production method for producing a new product conforming to the request on the basis of the node which has been predicted by in the link prediction process.

14. A cosmetic production assistance method, comprising:
receiving, by a computer, a request pertaining to new cosmetic product development;
inferring, by the computer, a production method for producing a new product conforming to the request based on the request and a learned model which has learned a relation between (i) a component and efficacy of an existing product, which is an existing cosmetic product, and (ii) a method for producing the existing product; and
outputting, by the computer, information indicating the production method which has been inferred.

15. A computer-readable non-transitory storage medium storing a cosmetic production assistance program for causing a computer to carry out:
a process of receiving a request pertaining to new cosmetic product development;
a process of inferring a production method for producing a new product conforming to the request based on the request and a learned model which has learned a relation between (i) a component and efficacy of an existing product, which is an existing cosmetic product, and (ii) a method for producing the existing product; and
a process of outputting information indicating the production method which has been inferred.
